(19) United States
(12) Patent Application Publication
(10) Pub. No.: US 2013/0110537 A1
(43) Pub. Date: May 2, 2013

(54) Cloud-based Medical Imaging Viewer and Methods for Establishing A Cloud-based Medical Consultation Session

(71) Applicant: Douglas K. Smith, San Antonio, TX (US)

(72) Inventor: Douglas K. Smith, San Antonio, TX (US)

(21) Appl. No.: 13/714,620

(22) Filed: Dec. 14, 2012

Related U.S. Application Data
(63) Continuation-in-part of application No. 13/354,219, filed on Jan. 19, 2012.
(60) Provisional application No. 61/721,731, filed on Nov. 2, 2012.

(51) Int. Cl. G06F 19/00

(52) U.S. Cl. 705/2

(57) ABSTRACT

A viewing system and methods for medical consultation includes an electronic medical records (EMR) system and a cloud viewing network. The EMR system includes a PACS having a PACS image file and the cloud viewing network includes a non-diagnostic viewing module having a non-diagnostic radiological viewer and a tooling module. The non-diagnostic radiological viewer displays a non-diagnostic PACS image based on the corresponding PACS image file to an authorized user accessing the non-diagnostic PACs image through user equipment interfaced with the network. With successful user verification, methods for medical consultation with the viewing system includes the step of sharing network status with the at least one authorized user of the viewing system via a network status social network indicator. The viewing system sends a consultation session invitation for a cloud-based, physician curbside consultation session. Optionally, a non-diagnostic PACS file is viewed and, optionally, edited during the consultation session.

### CROSS REFERENCE TO RELATED APPLICATIONS

This application is a Continuation-in-Part of application Ser. No. 13/354,219 filed Jan. 19, 2012, and further claims benefit under 35 U.S.C. §119(e) from prior U.S. Provisional Patent Application Ser. No. 61/721,731 filed on Nov. 2, 2012 entitled “Methods for Establishing A Cloud-based Medical Consultation Session”, by inventor Douglas K. Smith, MD, the entirety of disclosures of the above referenced Applications is hereby incorporated by reference as if fully set forth herein.

### TECHNICAL FIELD

The present disclosure relates generally to communication systems and in particular to a modular, cloud-based medical imaging viewer system and methods for non-diagnostic viewing of medical imaging including Picture Archiving and Communication System (hereinafter “PACS”) images whereby the system includes a cloud viewing network that interfaces with an electronic medical records system, such as among others a PACS and provides a venue for secured consultations for authorized users where such consultations, optionally, include viewing of non-diagnostic medical imaging while in compliance with government regulations regarding electronic protected health information (hereinafter “ePHI”).

### BACKGROUND

Many of today's healthcare administration systems within the field of radiology continue to rely on medical imaging files that are commonly created in response to a specific patient need and stored on a practice group's, hospital's, and/or imaging center's private local area network (hereinafter “LAN”) and operationally supported by a PACS. Presently, medical imaging files supported on a PACS consume large amounts of digital memory relative to the memory consumption of document files. Medical imaging files are often subject to proprietary formatting applied by a combination of PACS equipment manufacturers as well as a practice group's, hospital's, and imaging center's individual computer networks. In practice, the proprietary impediments to electronic data transfer between PACS systems and between PACS and electronic medical record (hereinafter “EMR”) systems is impaired because of, among others, proprietary software incompatibilities and reluctance of medical entities to share access to those data files within their control. Instead, imaging centers typically provide medical imaging files on radiographic film, printed material, and reformatted “user-friendly” files on digital memory storage media, such as a Compact Disk (“CD”).

Practically, each medical imaging file supported by a PACS requires large amounts of digital memory, averaging between 30-150 Megabytes (MB) per file, and are not always feasible to send across the internet as such files create transmission latency and file incompatibility issues with the majority of computers that do not accommodate PACS files among others. Due to software and hardware incompatibility issues commonly designed into most commercially-available systems, outpatient or clinical physicians do not typically refer to PACS systems in their practices. PACS software is often designed to run on a single licensed private medical network with just one PACS software application, namely, designed for running on a single computer that is often incompatible with PAC software systems from other vendors. Moreover, due to ePHI privacy regulations, PACS software systems require greater security measures including frequent password changes that make continuous access PACS files difficult and often impractical for outpatient or clinical physicians.

Moreover, there is presently no known uniformly adopted industry standard for securely transporting medical imaging files across the internet while in compliance with government regulations regarding ePHI. Because of gravely detrimental legal and economic liabilities at issue, sending medical imaging files online from a radiology practice group to an authorized requestor is presently a rare exception at best.

Inasmuch, today's medical imaging files are commonly provided on digital memory storage media and other means that are indirectly provided from the PACS and the radiology practice group's private LAN. Unfortunately, once the medical imaging files are received, it is often quite difficult to follow-up and successfully contact the radiologist or other radiology professional associated with the medical imaging files and final radiology report for a “curbside consultation”.

For example, if a referring surgeon would like a brief consultation of a few minutes with a radiologist regarding magnetic resonance imaging (hereinafter “MRI”) files provided in the radiologist's final report prior to surgery, then the surgeon's staff typically expends considerable time and effort in communication between the surgeons office and radiologist's office to locate the radiologist to simply set up a time to call one another on the telephone. Emails or other electronic messaging are presently not always feasible due to legal compliance issues with government ePHI regulations. As it is well understood in the medical field, health professionals are subject to tightly controlled workflow schedules, the radiologist in the illustration will quite often not be available to provide answers in real-time to simple informal questions from any recipient through a quick telephone conference of five minutes or less. Notably, the administrative efforts of locating a specific health professional for follow-up and setting a time for either a brief informal conference or a non-billable consultation is often labor intensive, costly, and takes significantly longer to administratively arrange than the actual brief consultation.

As a standard term in the medical industry, the terms “curbside consultation” or “sidewalk consultation” refers to an informal and unofficial consultation obtained from a health professional by either a fellow health professional or a layperson. Unfortunately, there is no known computer based system to identify the real-time network status of individual health professionals so as to permit a secured venue for these “curbside consultations” with the electronic sharing of ePHI including medical imaging files.

As specific to radiology, there no known secured cloud-based viewer for providing medical imaging files as a means for collaboration among authorized radiologists, health professionals, and laypersons. There exists a need to optionally provide a secured cloud-based viewing system with a radiology social network referral system. In one aspect, each graphical user interface for operating the secured, cloud viewing network is displayed at least in part as a component of each dashboard generated by the radiology social network referral system.

In one aspect, there exists a need to identify the real-time network status of individual health professionals within the radiology social network referral system to assist in facilitating a secured venue for these “curbside consultations”. As specific to radiology and related medical practices, a curbside consultation includes a secured cloud-based viewer for providing medical imaging files as a tool for collaboration including informal collaboration. Optionally, alternative aspects of the cloud viewing network provide for curbside consultations in other fields of medical practice without a non-diagnostic viewing module for providing medical imaging files. The cloud viewing network, in one aspect, provides a secured venue for physicians to collaborate in a patient's care by selecting key images, documents, and reports that enable a medical professional to quickly understand a patient's medical needs. Each collaboration session on the cloud viewing network is scalable in that authorized physicians and other medical professionals can join and leave the session as needed.

Accordingly, there exists a need for a cloud based method and system for viewing non-diagnostic PACS image files by authorized users. Furthermore, there exists a need for providing methods for radiological consultation including establishing a cloud-based consultation session among authorized users.

### DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

FIG. 1, in general, is a system diagram illustrating one aspect of a viewing system in accordance with embodiments of the present disclosure featuring a cloud-based non-diagnostic viewing module whereby, when interfaced with an electronic medical records system such as a PACS, provides a venue for secured consultations for authorized users where such consultations, optionally, include viewing of non-diagnostic medical imaging while in compliance with government regulations regarding ePHI;

FIG. 2 is a system diagram illustrating one aspect of a viewing system communicatively connected to a radiology social network referral system, the radiology social network referral system including a health administration server for rendering user-specific dashboards, the viewing system features a cloud-based non-diagnostic viewing module communicatively connected to the health administration server, in operation the cloud-based non-diagnostic viewing module provides a venue for secured synchronous and asynchronous consultations for authorized users while in compliance government regulations regarding ePHI, where such consultations, optionally, include viewing of non-diagnostic medical imaging while in compliance with government regulations regarding ePHI;

FIG. 3 is a system diagram illustrating a viewing system including a electronic medical records system and a cloud viewing network each on a cloud-based network architecture;

FIG. 4 is a system diagram illustrating a viewing system including a electronic medical records system and a cloud viewing network each on a virtual private network architecture;

FIG. 5 is a schematic diagram of a graphical user interface for a operating the non-diagnostic viewing module illustrating a master authorized user dashboard;

FIG. 6 is a systems diagram of a cloud-based non-diagnostic viewing module communicatively connected to an electronic medical records system, such as among others a PACS, a Radiology Information System (hereinafter “RIS”), and a Health Information System (hereinafter “HIS”), the cloud-based non-diagnostic viewing module including a non-diagnostic image file navigator;

FIG. 7 is a schematic diagram of a graphical user interface for operating the cloud viewing network illustrating a cloud viewing network dashboard, the cloud viewing network dashboard operating a non-diagnostic viewer during a synchronous cloud-based consultation session;

FIG. 8 is a schematic diagram of a graphical user interface for operating the cloud viewing network illustrating a cloud viewing network dashboard, the cloud viewing network dashboard operating a non-diagnostic viewer during an asynchronous cloud-based consultation session;

FIG. 9 is a flow diagram illustrating one exemplary embodiment of a method for establishing a cloud-based medical consultation session among authorized users;

FIG. 10 is a flow diagram illustrating one exemplary embodiment of a method for a cloud-based radiological consultation;

FIG. 11 is a schematic diagram of a graphical user interface for a operating the non-diagnostic viewing module illustrating a patient's homepage dashboard, the patient homepage dashboard collectively providing a comprehensive directory listing of all radiologist final reports for that specific patient;

FIG. 12 is a schematic diagram of a graphical user interface for a operating the non-diagnostic viewing module illustrating a patient review dashboard, the patient dashboard including a feedback interface for rating and reviewing each radiologist report, the patient review enables each physician or medical user that is authorized to access the non-diagnostic viewing module to interactively review each radiologist report selected on the directory listing from a patient's homepage dashboard, accordingly while in operation the dashboard continues to display information to the physician although the authorized physician is redirected from the cloud-based viewing module to a radiologic referral social network that stores the desired radiologist report for detailed viewing of the report on the non-diagnostic viewing module;

FIG. 13 is a schematic diagram of a graphical user interface for a operating the non-diagnostic viewing module illustrating a cloud viewing network dashboard, the cloud viewing network dashboard operating a non-diagnostic viewer shown in FIG. 13 as displaying a non-diagnostic PACS image file;

FIG. 14 is a schematic diagram of a graphical user interface for operating the cloud viewing network illustrating a peer dashboard for an authorized user, the authorized user is shown as a radiologist where the dashboard displays the profiles of a requesting user's peers to include, among others, the profiles of each peer, a favorites interface, social media indicators such as network status of users of a viewing system as well as corresponding ratings and reviews of the peer users;

FIG. 15 is a schematic diagram of a graphical user interface for operating the cloud viewing network illustrating a peer dashboard for an authorized user, the authorized user is illustrated as the radiologist of FIG. 14 where the dashboard displays a referring physician's “Client MDs” network list of those referring physicians that provide work product to the radiologist and further displays a “Shared Patients” list of patients shared by the radiologist and “Client MDs”;

FIG. 16 is a schematic diagram of a graphical user interface for operating the cloud viewing network illustrating a peer dashboard for an authorized user, the authorized user is illustrated as the radiologist of FIG. 14 where the dashboard displays a referring physician's consultant physician's or “Consultant MDs” network list of those physicians that the radiologist collaborates with on radiology orders for patients, the dashboard displays one aspect of a network status social media indicator for the referring physician in the illustration to assist the referring physician in determining the network real-time availability of specific “Consultant MDs” from the “Consultant MDs” network list, illustratively, this network status social medial indicator feature allows a user to quickly determine if another user or “Consultant MD” is currently online and thereby immediately available for consultation;

FIG. 17 is a schematic diagram of a graphical user interface for operating the cloud viewing network illustrating an authorized user's medical imaging centers dashboard, the imaging centers' dashboard displays at least one selection set of filter tools for choosing a desired imaging center from a real-time updated list, the at least one selection set is based on policy configurations and shared information;

FIG. 18 is a schematic diagram of a graphical user interface for operating the cloud viewing network illustrating an authorized user's medical imaging centers dashboard, the imaging centers' dashboard displays a list of favorite imaging centers based on shared information from the radiologic referral social network;

FIG. 19 is a schematic diagram of a graphical user interface for operating the cloud viewing network illustrating an authorized user's medical imaging centers dashboard, the imaging centers' dashboard displays an imaging center's detailed information profile where the displayed imaging center is from a list of imaging centers provided by the dashboard and updated in real-time;

FIG. 20 is a schematic diagram of a graphical user interface for operating the cloud viewing network illustrating a HELP cloud viewing network service tool dashboard for initiating “Network Administrative Services”, “Admin”, or a cloud viewing network system service tools, the HELP cloud viewing network service tool dashboard engages a user help request sequence that includes requesting help from a network administrator that operates a viewing network;

FIG. 21 is a schematic diagram of a graphical user interface for operating the cloud viewing network illustrating a RADIOLOGIST HELP cloud viewing network service tool dashboard for initiating “GoToRad” or cloud viewing network system service tools, the RADIOLOGIST HELP cloud viewing network service tool engages a cloud-based consultation session sequence, such as requesting a consultation session with a radiologist; and

FIG. 22 is a schematic diagram of a graphical user interface for operating the cloud viewing network illustrating a RADIOLOGIST IM HELP cloud viewing network service tool dashboard that is a specific instance of the RADIOLOGIST HELP cloud viewing service tool dashboard of FIG. 21, the RADIOLOGIST IM HELP cloud viewing network service tool dashboard initiates “HelpMeRad” or cloud viewing network system service tools, RADIOLOGIST IM HELP cloud viewing network service tool dashboard initiates a user request for help from a radiologist, such as initiating an instant messaging sequence between the requested authorized user and a desired radiologist.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DESCRIPTION

Generally speaking, pursuant to various embodiments, the present disclosure provides a cloud-based medical image viewing system and methods for use. The viewing system generally includes an electronic medical records system, a cloud viewing network, and at least one dashboard. In one aspect, the electronic medical records system includes a diagnostic radiology imaging system. The diagnostic radiology imaging system includes a Picture Archiving and Communications System, PACs, that includes a PACS image file. The cloud viewing network includes a non-diagnostic viewing module. In one aspect, the non-diagnostic viewing module includes a non-diagnostic radiological viewer and a tooling module, the non-diagnostic radiological viewer is communicatively connected to the tooling module and the PACS. In operation, via the at least one dashboard, the non-diagnostic radiological viewer displays a non-diagnostic PACS image based on the corresponding PACS image file to an authorized user accessing the non-diagnostic PACs image through user equipment that is interfaced with the cloud viewing network. The viewing system 501 provides at least one dashboard as a graphical user interface for operating the cloud viewing network 510.

In one further aspect, generally, a method for medical consultation includes the step of verifying user authorizations of a requesting user with respect to a viewing system whereby the authorizations are in compliance with governmental regulations regarding ePHI. With successful verification, the requesting user receives from the viewing system user network status of at least one authorized user of the viewing system that is authorized to communicate with the requesting user. The viewing system shares user network status of the requesting user with the at least one authorized user of the viewing system via a network status social network indicator.

The viewing system sends an invitation, such as a consultation session invitation. Illustratively, the consultation session invitation comprises a curbside consultation session invitation such as, among others, a physician curbside consultation session and a physician curbside consultation session between a radiologist and at least one other physician. Optionally, the viewing system applies a session timer sequence to, either synchronously or asynchronously, establish the consultation session.

In at least one aspect, a non-diagnostic PACS file is viewed and, optionally, edited during the consultation session with a cloud-based non-diagnostic viewing module, provided by the viewing system, such that the module leaves a “zero footprint”, that is the module does not download or maintain information such as ePHI and other security and privacy information on user equipment 5. Accordingly, a “zero footprint” viewer does not require permanent installation onto each end user device (i.e. user equipment). The images in one exemplary embodiment are displayed on user equipment 5, such as a tablet computer, on at least one web-page interfaced dashboard 15 provided by the viewing system 501 to thereby create a secure, encrypted venue for computer user to interact with the images. Other than a web-page, those of ordinary skill in the art will readily recognize other well known means for providing at least one dashboard 15 as in interface to the viewing system 501. Accordingly, the cloud-based non-diagnostic viewing module optionally assigns regulatory-compliant metadata with each update during the curbside consultation session. As a further option, the consultation session is appended as an addendum to the related final radiologists report.

Illustrative embodiments of the present disclosure and appended claims, as described below, are generally applicable to the viewing system that includes user equipment (UE), a cloud viewing network, an electronic medical records (hereinafter “EMR”) system, and, optionally, a radiology social network referral system. In one aspect, the EMR system and, optionally, the radiology social network referral system includes networks based on network infrastructure of a type well known in the industry, such as LAN architecture or a combination of LAN, wide area network (hereinafter “WAN”) architecture, and internet protocol network architecture, TCP/IP. The EMR system and, optionally, the radiology social network referral system are in part based on infrastructure well known in the industry includes, among others, a number of infrastructure devices for facilitating communications to user equipment operating in each system. Such infrastructure devices include elements of a radio access network (RAN) or simply access network that communicate with the subscriber units via an air interface, such as for instance, eNodeBs, base radios, base stations, base transceiver stations, and the like. Such infrastructure devices further include elements of an infrastructure core (e.g., a UMTS-3G core network for a 3G or GSM/EDGE system; an Evolved Packet Core (EPC) in an LTE system etc.) used to manage the allocation of radio resources of the network, with the infrastructure core including elements such as for instance, Mobility Management Entities, Signaling Gateways, Health Level 7 (HL7) MTS adapter core engines, Packet Data Network Gateways, etc. Other infrastructure devices that may be included in any one or each of the disclosed networks includes, but are not limited to, switches, zone controllers, base station controllers, repeaters, access points, routers, etc.

In one aspect, the EMR system and, optionally, the radiology social network referral system include networks based in part on network infrastructure of a type well known in the industry, such as internet protocol network architecture, TCP/IP. Illustratively, in one embodiment among others, the EMR system and, optionally, the radiology social network referral system include any combination of a pharmacy network, a social network, a hospital/clinical network, an imaging center network, a radiologic network, and a virtual private network such as among others a Picture Archiving and Communication System (PACS), a Radiology Information System (RIS) and a Hospital Information System (HIS).

Illustratively, and at least in one aspect, the EMR system and, optionally, the radiology social network referral system may at least in part comprise either a private 3G or GSM/EDGE system for supporting HL7 such as among others a hospital network 3G system or a public 3G system such as among others a commercial carrier commercial mobile phone EDGE system. Alternatively, each network from the EMR system and, optionally, the radiology social network referral system may at least in part comprise either a private 4G Long Term Evolution (LTE) system for supporting m-health, such as among others a hospital network 4G LTE system or a public 4G LTE system, such as among others a commercial carrier for mobile 4G LTE systems.

In at least one aspect, the EMR system and, optionally, the radiology social network referral system may at least in part include at least one network includes an International Mobile Telecommunications-2000 (IMT2000) based network designed to meet IMT-2000 standards, such as among others a private radiologic imaging center or a public 3G system, such as among other a commercial carrier mobile 3G systems. However, the plurality of networks can comprise any combination of 3GPP (3^{rd} Generation Partnership Project), broadband, legacy or non-3GPP radio access type systems including but not limited to LTE systems, Wireless Local Area Network (WLAN) systems, and Code Division Multiple Access (CDMA) systems, GPRS (general packet radio service) systems, Land Mobile Radio (LMR) systems, and WiMAX (Worldwide Interoperability for Microwave Access) systems. Among other messaging applications, mobile devices and other telecommunication systems are increasingly relying on internet protocols such as Session Initiation Protocol (SIP) for creating, modifying, and terminating communication sessions with one or more participants using a combination of multimedia applications, such as for voice and video.

In one aspect, the cloud viewing network is based on cloud computing architecture. For purposes of illustration in this disclosure and appended claims, the cloud viewing network, in one aspect, is applied to a self-hosted private cloud architecture. In other aspects, the cloud viewing network is applied to either a dedicated public cloud or, alternatively, a partner-hosted private cloud. Those of ordinary skill in the art will readily recognize any applicable cloud computing architecture for the cloud viewing network.

In one aspect, the EMR system and, optionally, the radiology social network referral system are at least in part based on cloud computing architecture. For purposes of illustration in this disclosure and appended claims, the EMR system and, optionally, the radiology social network referral system are applied to a self-hosted private cloud based architecture. In other aspects, the EMR system and, optionally, the radiology social network referral system are applied to either a dedicated public cloud or, alternatively, a partner-hosted private cloud architecture. Those of ordinary skill in the art will readily recognize any applicable cloud computing architecture for the EMR system and, optionally, the radiology social network referral system.

At times, as described herein for purposes of this disclosure and appended claims, the terms among others “Patients”, “Medical Facilities”, “Radiologist”, “Physician”, “Referring Physician”, “Client MDs”, “Consultant MDs”, “Medical Professional”, “Healthcare Professional”, “Healthcare Administrator”, “Billing Professional”, “Heath Provider”, “Pharmacist”, “Combat Medic/Corpsman”, “Information Technology Professional”, “Technician”, “Imaging Center”, “Center(s)”, “Peer”, “Administrator” or “Admin”, “Originator”, “Favorite”, “Network Entity”, “Participant”, “Node”, “User”, “User Agent Client”, “Client”, “User”, “Petitioning User”, “Requesting User”, “Subscriber(s)” and “Source/Destination Endpoint” are used interchangeably for a logical network endpoint that transmits or receives Internet Protocol messages such as among others SIP messages through a user agent server. It is understood that “user” or “subscriber” refers to one or more operators of user equipment (UE). Those of ordinary skill in the art will readily recognize various embodiments of UE, for purposes of illustration in this disclosure, the UE comprises either a wireless mobile device, such as among others a smart phone or tablet computer, or a wired device, such as among others a desktop computer, work station or a kiosk. Moreover, as described herein for purposes of this disclosure and appended claims, the terms “radiology” and “teleradiology” are used interchangeably for field of radiological medicine.

The users can be members of a “consultation session”, “consultation group”, “work request group”, “group” or “talk group” that include a combination of preconfigured users, ad hoc users or members. Alternatively, subscribers may not be members of such groups.

A viewing system features an EMR system and, optionally, a radiology social network referral system where it is possible for a user to be a member of any combination of groups and users. Illustratively, in one embodiment, a radiologist, as a user, accesses the viewing system which authenticates and authorizes the radiologist while in the role of a staff member of a hospital system to access images on the cloud based viewing system from a network entity, such as an imaging center. Thus, the radiologist views images residing on the private cloud-based viewing system while viewing a secure user interface rendering, such as a web page, of the patient's images on his tablet viewing device while the radiologist is physically located off-site from the hospital system. Moreover, a surgeon at a surgical suite in another country authenticates and authorizes into the viewing system and establishes a curbside consultation with the radiologist to quickly review a patient's images prior to performing surgery on the patient. Both the surgeon and the radiologist view the same information, via user interface, that resides on the cloud based viewing system that displays the patient's image data files that are ultimately stored in an EMR system. The actual patient data file is not transferred and downloaded to either end user device (user equipment) but both users simultaneously view the same secure information displayed by the viewing system and ultimately maintained by the EMR system or radiology social network referral system. residing on the private server. Optionally, one of the users annotates at least one physician's finding in question directly on the image on the image being discussed with the viewing system using a tooling module that includes among others HTML5 tools in one embodiment.

In a further illustration, an endpoint, such as case manager assigned by a referring physician for managing a particular patient, may be a concurrent member of a clinical network entity, a radiology network entity, and a social network entity. On behalf of the referring physician, the case manager is authenticated by a viewing system for access to the radiologist's clinical network entity but is not authorized to directly consult with the radiologist regarding an imaging center preferred by the radiologist but is authorized to view the radiologist's favorites interface and to instead speak with the radiologist's office manager from the clinical practice group in that the viewing system assigned the same authorizations for the role of healthcare manager.

In this disclosure and appended claims the term “real time” “real-time” refers to denoting or relating to a computer system that constantly updates information at the same rate as the system receives data, and processes data sufficiently rapidly to be able to control a process. Illustratively, a real-time web user interface of an application remains in continuous communication with a corresponding server while the user remains connected.

In this disclosure and appended claims, the term “network status”, “social network status”, “login status”, “user login status” or “user status” refers to the state of real-time activity exhibited by a user while connected, i.e. authenticated and, optionally, authorized, to a network for example, among others, an online user, a busy user, an instant message only user, an offline user, a temporality away user, and a logged out user. Those of ordinary skill in the art will readily recognize that a user can elect to display their status to other users of the network or, alternatively, an application can involuntarily display a user's network status.

In this disclosure and appended claims the term “data input” and “input” refers to data that is provided to the viewing system through user equipment. In particular, each user engages in a direct communication session with the viewing system by way of any combination of UE comprising hardware and software and/or firmware. The UE interfaces with the cloud viewing network such that all input is directly received by the cloud viewing system and does not remain on the interfacing UE.

In this disclosure and appended claims, the terms “Protected Health Information, PHI”, “electronic Protected Health Information, ePHI”, “ePHI related data”, “electronic health records”, “medical information”, “medical records”, “private information”, “patient medical file”, “patient information”, “health records”, “health information”, “health information technology” refer to health information that is regulated by industry standards and government regulations, among other means for regulation, and includes, among others security and privacy regulations, such regulations as, among others, the Security Standards for the Protection of Electronic Protected Health Information (the Security Rule) published Feb. 20, 2003 (45 C.F.R. Part 160 and Part 164, Subparts A and C) and established standards for protecting Health Information (ePHI) conveyed by electronic means (hence “ePHI”) (hereinafter referred to as “the ePHI security rule”); the Health Insurance Portability and Accountability Act (hereafter “HIPAA”) (Health Insurance Portability and Accountability Act of 1996 (HIPAA)); Public L. 104-191, 101 Stat. 1936, enacted Aug. 21, 1996, (see also the HIPAA Privacy Rule (See 45 C.F.R. §164.530(c) (technical safeguards for ePHI)) and the HIPAA Security Rule (See 45 C.F.R §§164.308, 164.310, and 164.312 (technical safeguards for ePHI)) (HIPAA Privacy and Security Rules refer to regulations for protecting the privacy and security of health information as developed by the Secretary of the U.S. Department of Health and Human Services (HHS).)); and the Health Information Technology for Economic and Clinical Health Act (HITECH Act) §13410(d) (see eg. Meaningful Use (of Health Information Technology) Proposed Final Rule March 2012 (addressing the privacy and security concerns of ePHI)); HITECH Act as part of the American Recovery and Reinvestment Act of 2009 (ARRA), Public L. 111-5, enacted Feb. 17, 2009 (hereinafter, collectively, referred to as “The HITECH Act”). In at least one embodiment, ePHI includes information associated with user identification and authorization.

In this application and appended claims the terms “non-diagnostic”, “non-diagnostic image file” and “non-diagnostic PACS image file” refers to an image of any resolution and compression for informal non-diagnostic reference as opposed to a formal “diagnostic” image in that the term “diagnostic” specifically refers to an image that is in compliance with Untied States governmental regulations, such as the United States Food and Drug Administration. Inasmuch, in this application and appended claims the terms “diagnostic”, “diagnostic image file”, “diagnostic PACS image file” and “PACS image file” refers to an image of any resolution and compression for formal diagnostic reference that is in compliance with Untied States governmental regulations, such as the United States Food and Drug Administration.

In this disclosure and appended claims the term “marking” refers to informal editing of a medical image file, such as among others, a non-diagnostic PACS image file.

In this application and appended claims the term “registration information” refers to information provided by each user on either registration or login with a viewing system and such registration information includes, among others, user identification information, authentication information, synchronization information, and ePHI. For example, registration information includes, among others: the user or patient's name, social security number, date of birth, and, optionally, biometric scan data, insurance policy number, and the medical entity ID number if the user is an employee.

In this disclosure and appended claims the terms “platformed”, “platformed network” refer to a network that includes a cloud-based Platform as a Service (PaaS) application with its network infrastructure. Illustratively, a radiologic imaging center includes the cloud viewing network, as a PaaS application module, into the imaging center's network infrastructure as a means for providing independently verified user access to radiologic imaging information to patients who wish to review their image files electronically while connected to the internet. As such, the cloud viewing network, as a component of the imaging centers infrastructure, ensures that the requesting patient is initially screened in accordance with HIPAA and other privacy and security protocols applied with the viewing system before the patient views their image that is stored within imaging center's network infrastructure.

While embodiments of the present disclosure employ various teachings of the aforementioned standards and protocols, the embodiments as described herein are not limited by these protocols. Those skilled in the art will realize that the above recognized advantages and other advantages described herein are merely illustrative and are not meant to be a complete rendering of all of the advantages of the various embodiments.

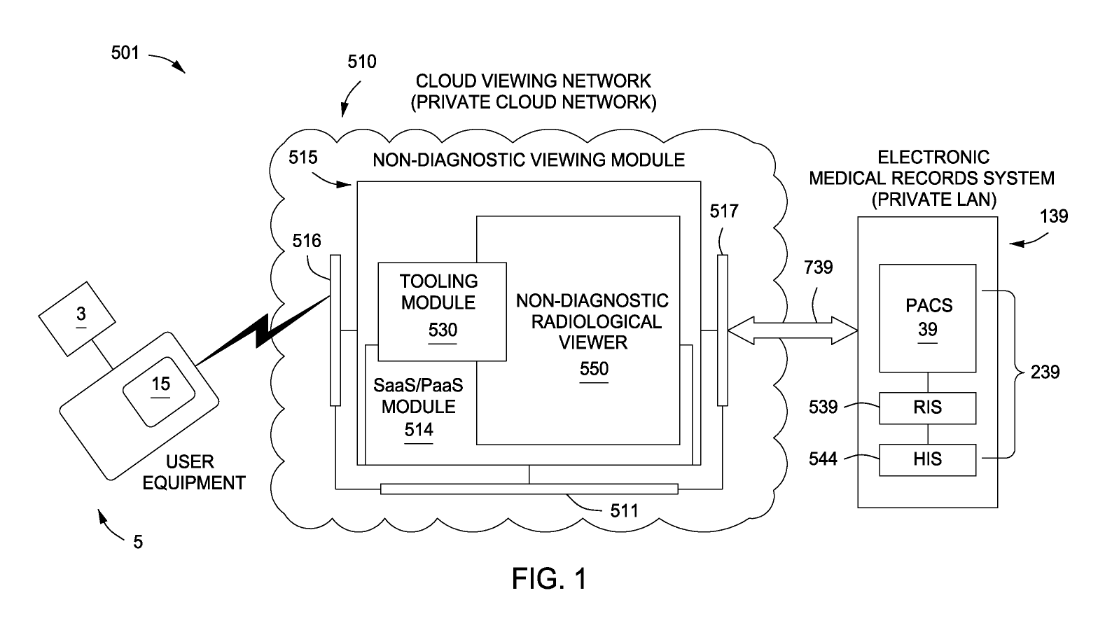

Referring now to the figures, FIG. 1 shows a cloud-based medical image viewing system 501. Generally, the viewing system 501 includes an electronic medical records (“EMR”) system 139 and a cloud viewing network 510. The viewing system 501 includes user equipment 5, such as a mobile device, that interfaces with the cloud viewing network 510.

In operation, with at least one dashboard 15 provided by the viewing system 501 and displayed on the user equipment 5, such as a tablet computer, a user 3 interfaces with the cloud viewing network 510. Each dashboard provides at least graphical user interface for operating the cloud viewing network 510 directly from user equipment 5 such a mobile device. Information provided by each dashboard 15 can, optionally, include ePHI. In one embodiment, the ePHI includes patient information that is not initially for patient access that is also referred to as “federated patient record(s)”.

Illustratively, a referring physician, as an authorized user 3 of the user equipment 5, operates the at least one dashboard 15 to interface with the cloud viewing network 510 to view non-diagnostic PAC image files as derived from diagnostic PACS image files from the official radiology report stored on the EMR system 139 to thereby quickly and securely gain perspectives on ePHI while in an exam room with the corresponding patient. Further, as described below, the referring physician in the illustration can further contact the radiologist who signed-off on the official radiology report with the dashboard 15 for either a synchronous or an asynchronous multimedia consultation session to briefly address some questions from the referring physician's user equipment 5, such as a mobile device, while the corresponding patient remains in the exam room.

Referring to FIG. 1, the EMR system 139 is communicatively connected to the cloud viewing network 510. In one aspect, the EMR system 139 is communicatively connected to the cloud viewing network 510 with a real-time HL7 interface 739.

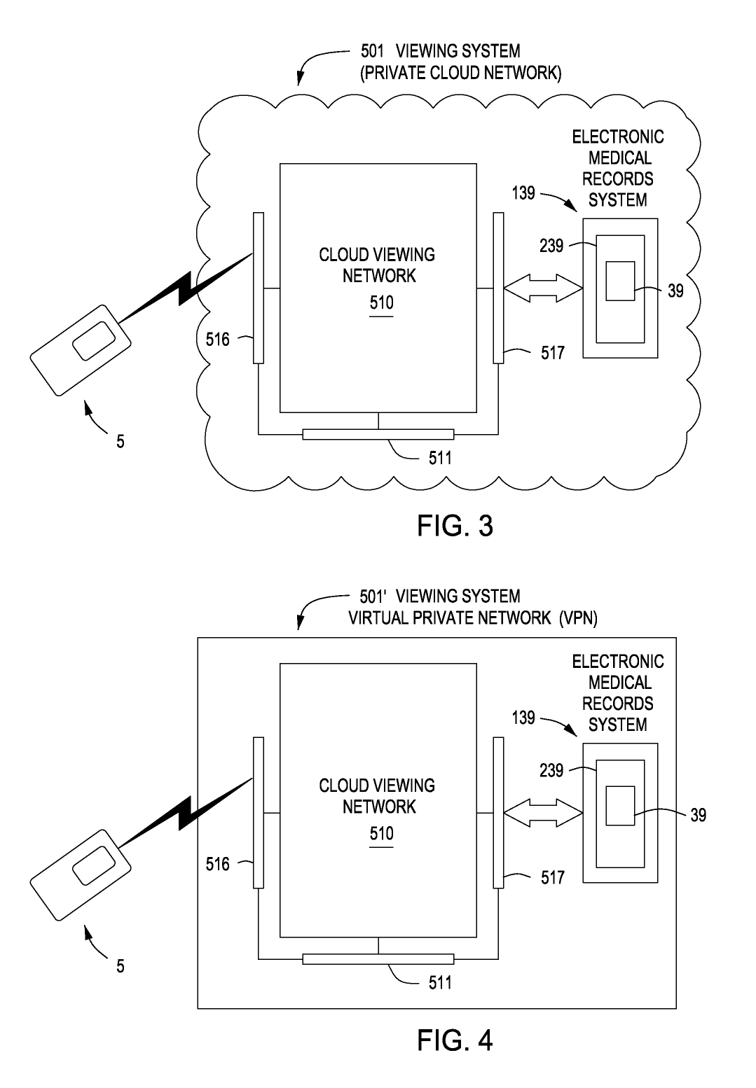

From a network architecture perspective, FIGS. 3-4 illustrate various embodiments of the viewing system 501. Those of ordinary skill in the art will recognize other network architecture configurations for the viewing system 501.

In particular, FIG. 3 is a system diagram illustrating a viewing system 501 that includes an EMR system 139 and a cloud viewing network 510 each on a cloud-based network architecture as shown. The EMR system 139 includes a diagnostic radiology imaging system 239. The diagnostic radiology imaging system 239 includes a PACS 39 of a type well known in the industry, a radiology information system (hereinafter “RIS”) 539, and a health information system (hereinafter “HIS”) 544. As shown, with user equipment 5, a user communicatively connects to interface with the cloud viewing network 510 and the EMR system 139 each on a cloud-based network architecture.

Alternatively, FIG. 4 is a system diagram illustrating a viewing system 501′ that includes an EMR system 139 and a cloud viewing network 510 each on a virtual private network architecture, such as a radiology practice group's private LAN. Those of ordinary skill will recognize an EMR system 139 and a cloud viewing network 510 each on a network infrastructure of a type well known in the industry, such as LAN architecture or a combination of LAN, WAN architecture, and internet protocol network architecture. As shown, the viewing system 501′ includes an EMR system 139 and a cloud viewing network 510. The EMR system 139 includes a diagnostic radiology imaging system 239 that features a PACS 39, a RIS 539, and a HIS 544. As shown, with user equipment 5, a user interfaces with the cloud viewing network 510 and the EMR system 139 each on a virtual private network architecture.

With continuing reference to FIG. 1, the EMR system 139 includes a diagnostic radiology imaging system 239. Generally, the electronic medical records system is of a type well known in the industry such as, among others, the electronic medical records system disclosed in US Patent Application Publication No. US2012/0116815A1 (May 10, 2012) to Douglas K. Smith that includes a PACS. In one aspect, the diagnostic radiology imaging system 239 includes a PACS 39, a RIS 539, and a HIS 544. Those of ordinary skill in the art will readily recognize that the EMR system 139 can include any combination of a PACS, a RIS, and a HIS.

The cloud viewing network 510 includes a non-diagnostic viewing module 515. In operation, the user 3, such as a medical professional, interacts with the at least one dashboard 15 displayed on the user equipment 5 to interface with the non-diagnostic viewing module 515. The non-diagnostic viewing module 515 provides a secure, cloud-based interface to an EMR system 139 while a medical professional or any authorized user 3 operates the user equipment 5.

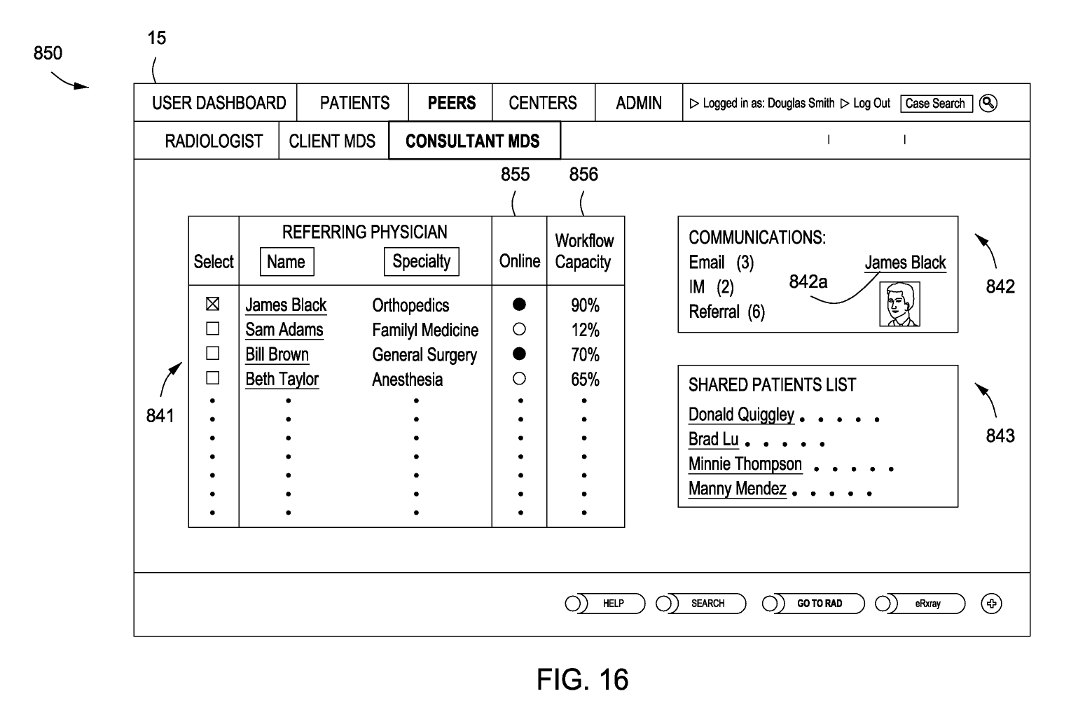

Moreover, the cloud viewing network 510 with the non-diagnostic viewing module 515 provides a secure, cloud-based venue for either a synchronous or an asynchronous multimedia consultation session with at least one authorized user of the viewing system 501 based on the authorized role of the requesting user. In one specific example, based on the authorized roles provided by each user's National Provider Identifier (hereinafter “NPI”), at least two physicians authorized with the viewing system 501 easily establish a secured, ePHI-compliant physician consultation session with the non-diagnostic viewing module 515 while on their respective user equipment 5. A network status social media indicator 855, provided by the non-diagnostic viewing module 515 and shown on the at least one dashboard 15 on FIG. 16, assists the requesting user to determine what authorized users are currently available for a quick synchronous consultation session or to alternatively provide information, such as among others questions and comments, asynchronously to a desired user that is not presently available for a consultation session through the non-diagnostic viewing module 515. It should be added that the non-diagnostic viewing module 515 can optionally provide non-diagnostic PACS image files as derived from diagnostic PACS image files from the EMR system 139 to thereby quickly and securely gain perspectives on the non-diagnostic PACS image files provided by the non-diagnostic viewing module 515 while in an exam room with the corresponding patient during any consultation session. In operation, the non-diagnostic viewing module 515 displays non-diagnostic images that can be viewed by properly authenticated and authorized users to view remotely on an end user viewing device. Moreover, in one aspect, a plurality of properly authenticated users can simultaneously view the same viewing module 515 display providing a non-diagnostic patient image. Accordingly, each user can annotate the image in question using HTML5 tools from the tooling module in one embodiment, and refresh the display to account for the updated annotation. The display providing the annotated image is simultaneously updated in the devices of all the users participating in the consultation session facilitated by the cloud viewing network. In this manner, all users participate in a real-time, interactive consultation session. The annotated images can be recorded in a patient's file as documentation of record arising from the consultation session. As such, sensitive ePHI including a patient's imaging file is not transmitted to any of the end user devices in that a patient's medical record with the annotated images remains archived on a secure cloud-based storage network. The non-diagnostic viewing module 515 that displays the annotated image provides a relatively much smaller digital file size (for example: 20-300 kb) compared to the file size of the patient's original imaging file (for example: 75-125 MB) so that data transfer rate is much faster when used in low bandwidth conditions such as 3GPP-based network transmissions. Because users are viewing a cloud-based non-diagnostic viewing module 515 rendering of a master imaging data residing on the secure cloud server such as a PACS, a patient's image file is not transferred to the viewing device(s) and such ePHI cannot be compromised if an end user device is subsequently lost or stolen.

As shown in FIG. 1, the non-diagnostic viewing module 515 includes a non-diagnostic radiological viewer 550 and a tooling module 530. The non-diagnostic radiological viewer 550 is communicatively connected to the tooling module 530 and the EMR system 139 including the PACS 39. In operation, the non-diagnostic radiological viewer 550 displays a non-diagnostic PACS image based on the corresponding PACS image file to an authorized user accessing the non-diagnostic PACs image on the at least one dashboard 15 through user equipment 5 that is interfaced with the cloud viewing network 510. In one embodiment, the tooling module 530 provides a limited tool set for manipulating a non-diagnostic PACS image as opposed to the full range of tools used by radiologists to establish a diagnosis based on a diagnostic PACS image file.

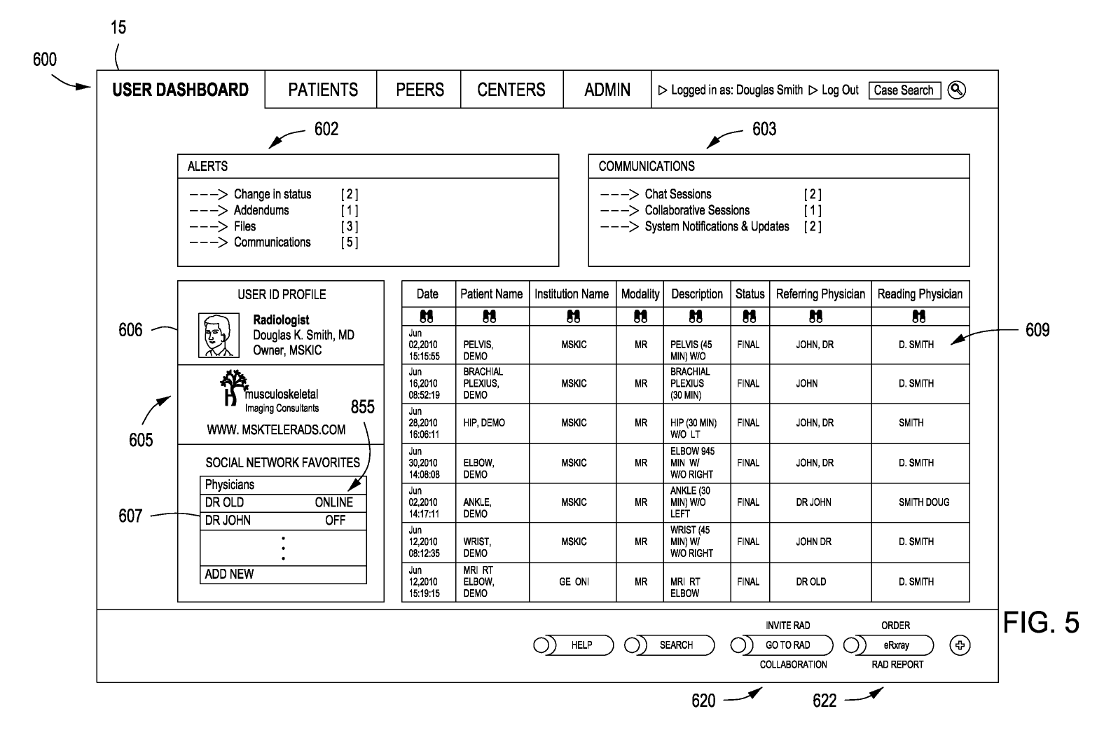

In one aspect, with at least one dashboard 15, the non-diagnostic viewing module 515 digitally displays information obtained from the EMR system 139, such as medical image files including PACS image files, or from any network that is external to the viewing system 501 on user equipment 5, such as a mobile device, in a secured manner and in compliance with government ePHI regulations. FIGS. 5, 7-8, 11-22 illustrate at least one dashboard 15 for providing at least one graphical interface for operating the cloud viewing network 510. In one embodiment, each dashboard 15 is generated by a health administration server 9 from the radiology social network system 1 provided by the viewing system 501 of FIG. 5 or, alternatively, generated by any well known means in the industry for providing at least one graphical user interface for operating the cloud viewing network 510.

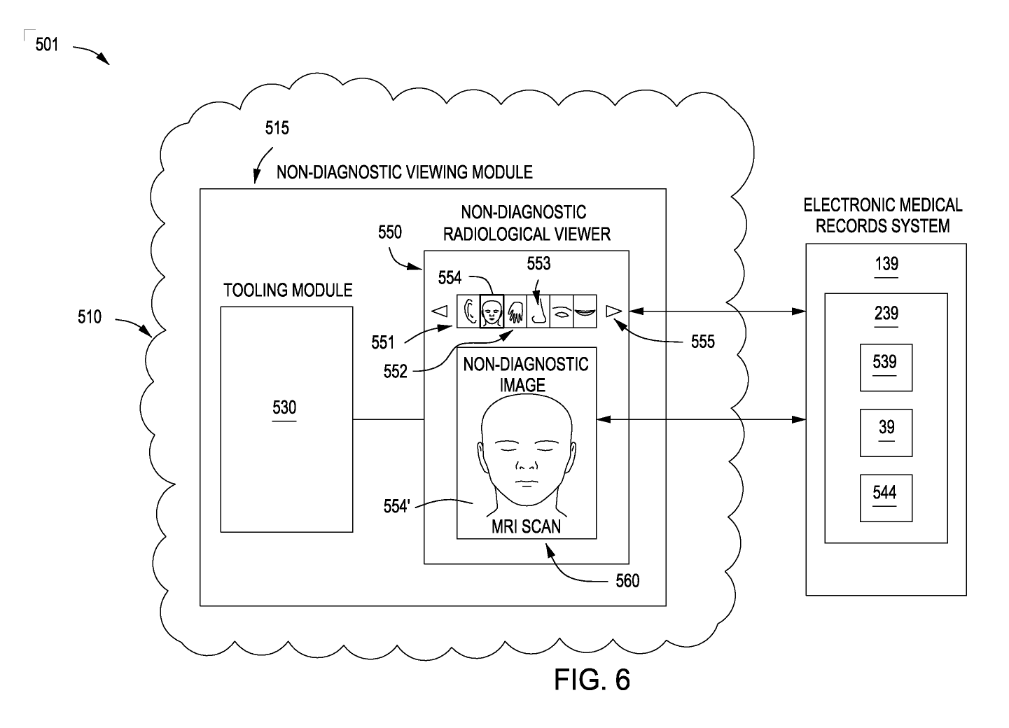

With reference to FIGS. 5-6, the non-diagnostic radiological viewer 550 is shown to include a non-diagnostic image file navigator 551 and a remote file viewbox 560. In operation, the non-diagnostic radiological viewer 550 is displayed as a component of the at least one dashboard 15, such as an application software component.

While on a secured, cloud-based network, the non-diagnostic radiological viewer 550 facilitates the authorized user 3 selection of a particular non-diagnostic PACS image file from a plurality of non-diagnostic PACS images where each non-diagnostic PACS image file has a corresponding diagnostic PACS image file acting as a master file for a particular image that is rendered on the EMR system 139. Typically, a diagnostic PACS image file is a file type that requires higher resolution memory and, apart from EMR systems, is often incompatible with most computers including user equipment. Each non-diagnostic PACS image file is an image of any resolution and compression for informal non-diagnostic reference as opposed to a corresponding diagnostic PACS image master file for a particular image that is rendered on the EMR system 139. Each non-diagnostic PACS image file is selected with the non-diagnostic image file navigator 551 and rendered on the remote file viewbox 660. In one embodiment, each non-diagnostic PACS image file is temporarily rendered on the remote file viewbox and then deleted as discussed in detail below.

In one exemplary embodiment, to minimize transmission latency and file incompatibility issues with the majority of computers that do not accommodate diagnostic image files rendered on EMR systems including diagnostic PACS image files, the non-diagnostic PACS image file is an irreversibly compressed or “lossy” image file of the corresponding diagnostic PACS image master file. Moreover, in compliance with government regulations provided by the United States, the non-diagnostic radiological viewer 550 ensures secured, cloud-based access of the non-diagnostic PACS image file to authorized users. Accordingly, as discussed further below, the cloud viewing network 510 includes an authentication and authorization module 511 communicatively connected to both the non-diagnostic viewing module 515 and the non-diagnostic radiological viewer 550 to facilitate secured, cloud-based access of the non-diagnostic PACS image file to authorized users. In one exemplary embodiment, the authentication and authorization module 511 interfaces with the viewing system 501 an ePHI compliant gatekeeper system of U.S. patent application Ser. No. ______ entitled “An ePHI-compliant Gatekeeper System and Methods” to Douglas K. Smith whereby the ePHI compliant gatekeeper system is a cloud-based service entity for verifying authentications and authorizations to the viewing system 501.

Shown in FIG. 6, the non-diagnostic image file navigator 551 includes a plurality of thumbnail renderings 552. Each thumbnail rendering 553 is a specific instance of a non-diagnostic PACS image file that corresponds to diagnostic PACS image that is a master file of an image that is rendered on an EMR system 139.

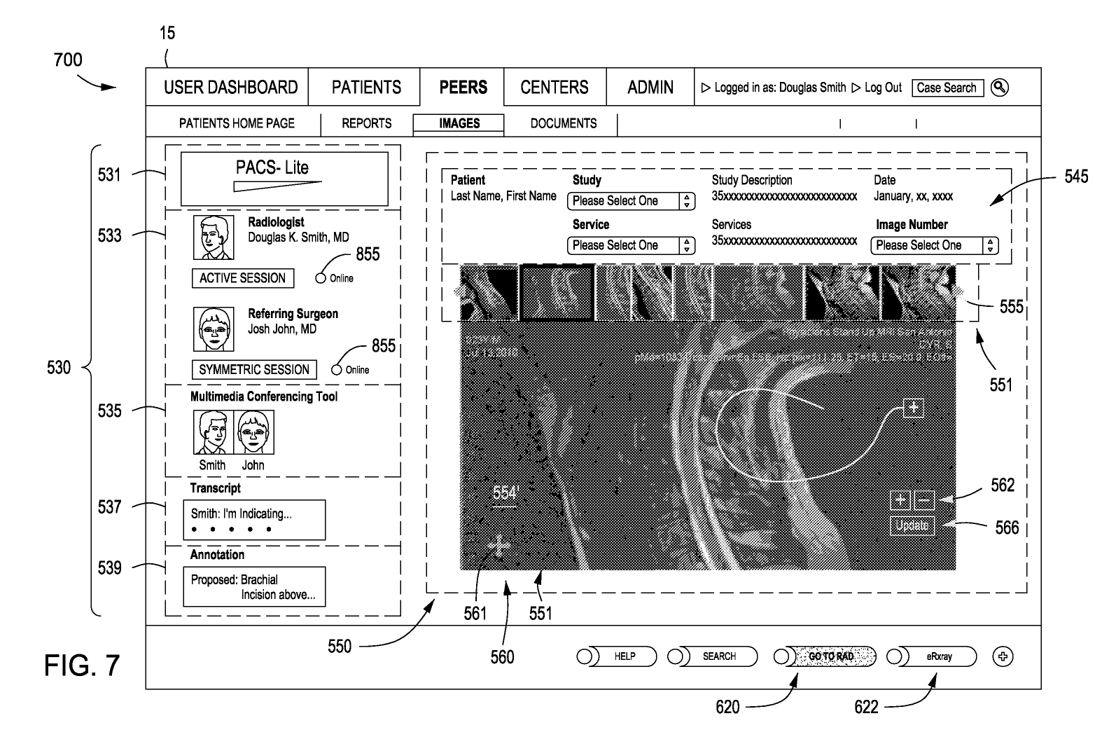

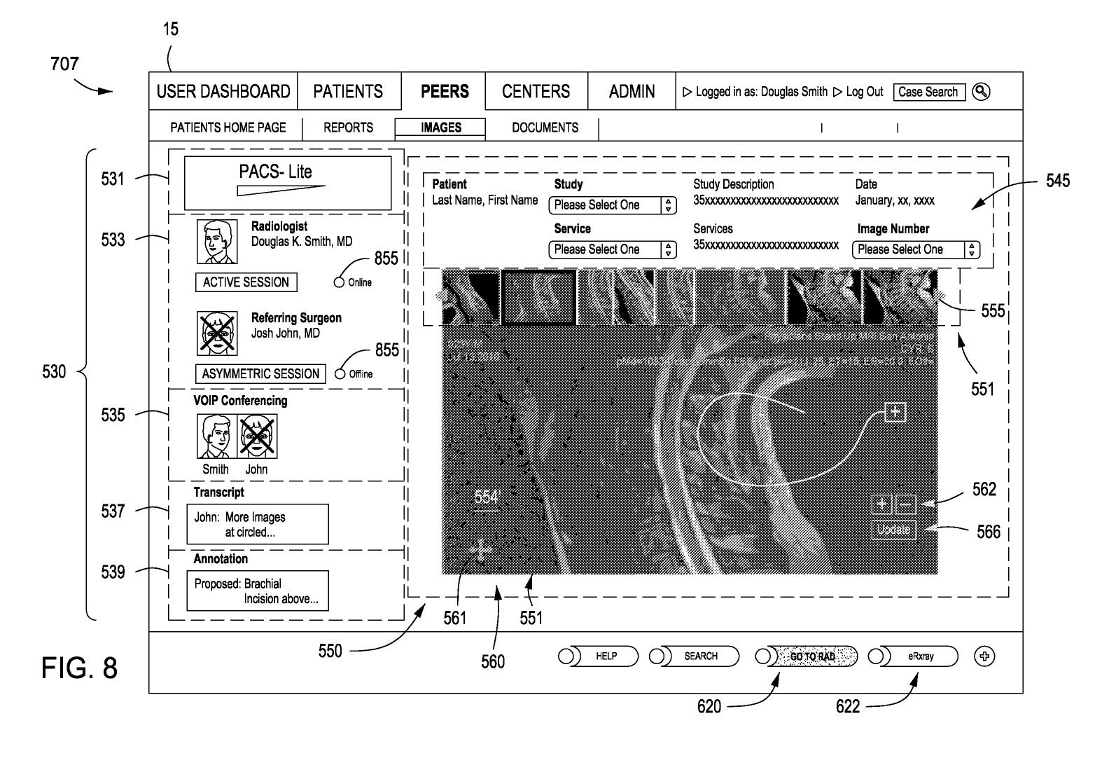

The non-diagnostic PACS image file navigator 551 includes thumbnail manipulation tool 555. In operation, as shown in FIGS. 7-8, the authorized user 3 applies the thumbnail manipulation tool 555 provided by the at least one dashboard 15 to browse the plurality of thumbnail renderings 552. A viewbox-activated, non-diagnostic PACS image file 554 is selected from the plurality of thumbnail renderings 552 with the thumbnail manipulation tool 555. The selected viewbox-activated non-diagnostic PACS image file 554 is rendered on the remote file viewbox 560. Specifically, as shown, a viewbox display image 554′ of the non-diagnostic PACS image file 554 is displayed on the remote file viewbox 560. In general, a viewbox display image 554′ is a higher resolution image than a thumbnail image 553 of the plurality of thumbnail renderings 552. The selected viewbox-activated non-diagnostic PACS image file 554, 554′, in one exemplary embodiment, is temporarily rendered on the remote file viewbox 560.

In one embodiment, each thumbnail rendering 553 is configured as a low resolution image file (for example a 1-10 kilobyte image file) to enable selection of a non-diagnostic PACS image file 554 for rendering on the remote file viewbox 560 with a higher resolution image file relative to each thumbnail rendering but less than the corresponding diagnostic PACS image file on the diagnostic radiology imaging system 239. Accordingly, the viewbox-rendered non-diagnostic PACS image file 554, 554′ is one instance of a non-diagnostic PACS image file. In one aspect, the non-diagnostic radiological viewer 550 matches each selected thumbnail rendering 553 with a corresponding, identical or “master” diagnostic PACS image files on the EMR system 139. In one exemplary embodiment, the remote file viewbox 560 configures the “master” diagnostic PACS image file to generate the corresponding non-diagnostic image file 554 for rendering on the remote file viewbox 560. In practice, patients and medical professionals other in addition to radiology professionals do not require access to a diagnostic PACS image file, including among others a diagnostic PACS image file of a relatively high resolution (250×250 or 48 kb) but only to review a non-diagnostic PACS image file and medical image file to quickly gain a perspective to treat a patient accordingly.

In one exemplary embodiment, the non-diagnostic PACS and medical image file 554 is a temporary rendering on the remote file viewbox 560 to assist non-radiology as well as radiology professionals to quickly gain perspectives for patient treatment on a secured, cloud-based venue by conveniently accessing user equipment 5 such as a mobile device provided by a commercial telecommunications carrier network. Specifically, in one embodiment, the cloud viewing network 510 displays the non-diagnostic PACS and medical image files 554 for a user requested viewing session and, optionally, for a consultation session as discussed below. The non-diagnostic PACS and medical image files are displayed by the cloud-viewing network 510 and accessed on user equipment 5 but the non-diagnostic PACS and medical image files are not permanently stored on the user equipment 5. After a predetermined period, the display on the cloud-viewing network and the non-diagnostic PACS and medical image files 554 are deleted from the viewing system 501 in that the non-diagnostic PACS and medical image files 554 do not remain stored in memory on the cloud viewing network 510. Optionally, in that the viewing system 501 is provided in at least one embodiment as a subscription Software as a Service and/or Platform as a Service, the non-diagnostic PACS and medical image files 554 as well as consultation sessions can be electronically added to an authorized user's electronic records on a network entity (such as among others an EMR system and a Storage as a Service cloud based entity) that is external to the cloud viewing network 510 prior to deletion from the cloud viewing network 510. In one embodiment, prior to deletion from the cloud viewing network 510, the non-diagnostic PACS and medical image files 554 as well as consultation sessions can be saved on a Storage as a Service entity of a cloud-based architecture that provides secured storage in compliance with government ePHI regulations. As such, the cloud viewing network 510 and the Storage as a Service entity are communicatively connected to one another, such as, among others, with an HL7 connection. Although the Storage as a Service entity is external from the cloud viewing network 510, other embodiments feature saving the non-diagnostic PACS and medical image files 554 as well as consultation sessions on the EMR system 139 prior to deletion from the cloud viewing network 510.

FIGS. 7-8 in one aspect, show a viewbox display image 554′ of the non-diagnostic PACS image file 554 displayed on the remote file viewbox 560. In one embodiment, the viewbox display image 554′ is a higher resolution image than a thumbnail image 553 of the same photo subject to facilitate marking such as editing and manipulations while displayed on the remote file viewbox 560 as opposed to the thumbnail image that provides visual indexing of corresponding images for retrieval on the EMR system 139.

FIG. 6 shows editor tools provided by the tooling module 530 for interfacing by manipulating and editing or, commonly, “marking” the viewbox display image 554′ rendered on the remote file viewbox 560. The editor tools include a mapping navigator 561 to facilitate with viewing the viewbox display image 554′ as desired and includes an orientation graphic and image enlargement/reduction features that are coupled to the mapping navigator 561 for viewing on the remote file viewbox 560. A draw tool 562 is provided as an editor tool for either adding or removing a line that is added as the cursor is manipulated over the viewbox display image 554′.

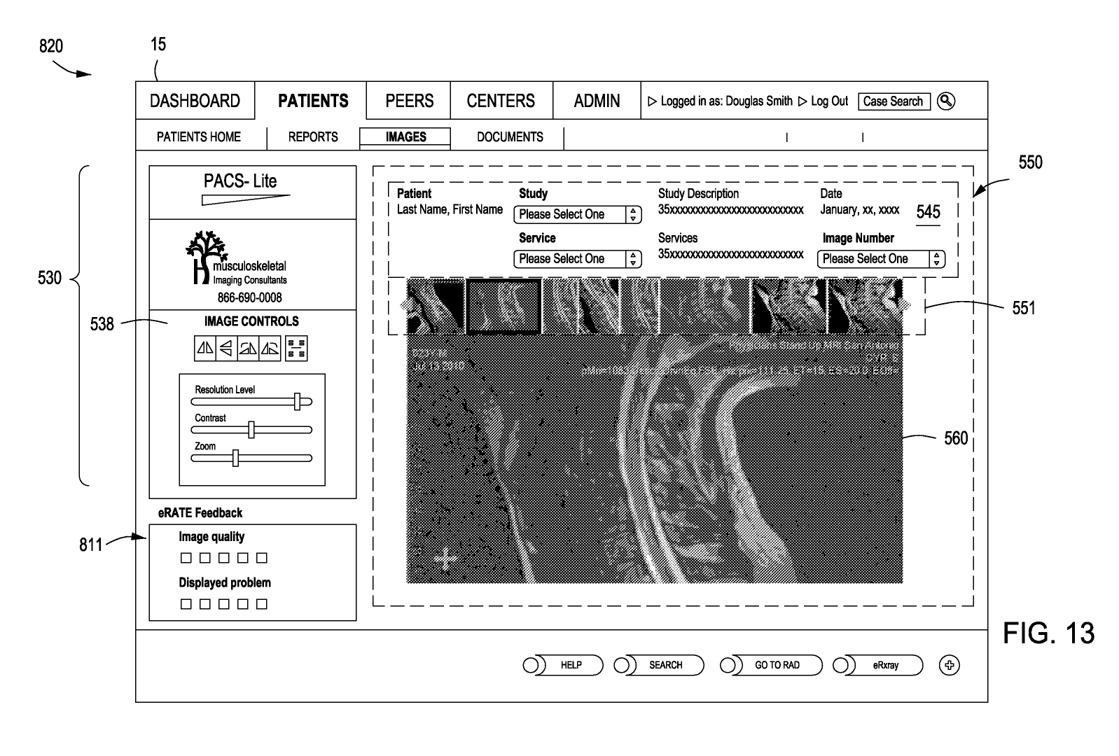

Moreover, FIG. 13 illustrates image controls 538 as editor tools provided by the tooling module 530. The image controls 538 include, among others, the resolution level, contrast, zoom, and rotation features as applied to the higher resolution viewbox display image 554′

FIGS. 7-8 show a file information viewer 545 further provided by the non-diagnostic radiological viewer 550. The file information viewer 545 generally provides information regarding the viewbox display image 554′ and the plurality of thumbnail renderings 552, such as among others identification information (for example the identification of the patient), imaging center and radiologist's cataloging information associated with the images.

Further referring to FIG. 7, the tooling module 530 includes other tools as shown. A non-diagnostic viewing module mode indicator 531 is displayed on the at least one dashboard 15 to inform the authorized user that the non-diagnostic viewing module 515 is in operation. As shown, the tooling module 530 includes at least one network status social media indicator 855 provided on the at least one dashboard 15 next to the authorized user's profile at other locations on the at least one dashboard 15.

FIGS. 7-8 show a synchronous/asynchronous communications monitor 533 provided by the tooling module 530. Illustratively, FIG. 7 shows the synchronous/asynchronous communications monitor 533 indicating a synchronous cloud-based consultation session 700 that is being facilitated through the at least one dashboard on the cloud viewing network 510. Similarly, FIG. 8 shows the synchronous/asynchronous communications monitor 533 indicating an asynchronous cloud-based consultation session 707 that is being facilitated through the at least one dashboard 15 on the cloud viewing network 510.

The at least one dashboard 15 shows a consultation session initiator 620 and a preorder radiology workflow initiator 622. The consultation session initiator 620 triggers a consultation session software application function provided by the viewing system 501 and, illustratively, communicatively connected to the tooling module 530 and the non-diagnostic radiological viewer 550. Therefore, each consultation session is provided by the cloud viewing network 510 and facilitated on the at least one dashboard 15. In one embodiment, the consultation session initiator 620 comprises a “Go To RAD” brand consultation session initiator provided by Musculoskeletal Imaging Consultants, LLC of San Antonio, Tex. As discussed in detail below, the consultation session initiator 620 triggers methods for medical consultation 650 and methods for radiological consultation 750 that each include operating the non-diagnostic viewing module 515 with the tooling module 530. Each method 650, 750 optionally includes a session timer sequence for facilitating either a synchronous or an asynchronous consultation session, as desired, within a predetermined period set by the requesting user initiating a session invitation. As an additional option, to conserve system bandwidth, each method 650, 750 is configured such that an entire consultation session sequence is completed within a predetermined period, such as among others a consultation session sequence lasting no longer than five minutes as brief curbside consultation between physicians. For example, one common consultation session sequence relates to brief questions regarding one or two image files such as “what is this finding on this image?”, “can you show me the salient finding” or questions determining whether the physicians participating in a consultation session share a common understanding of each patient issue.

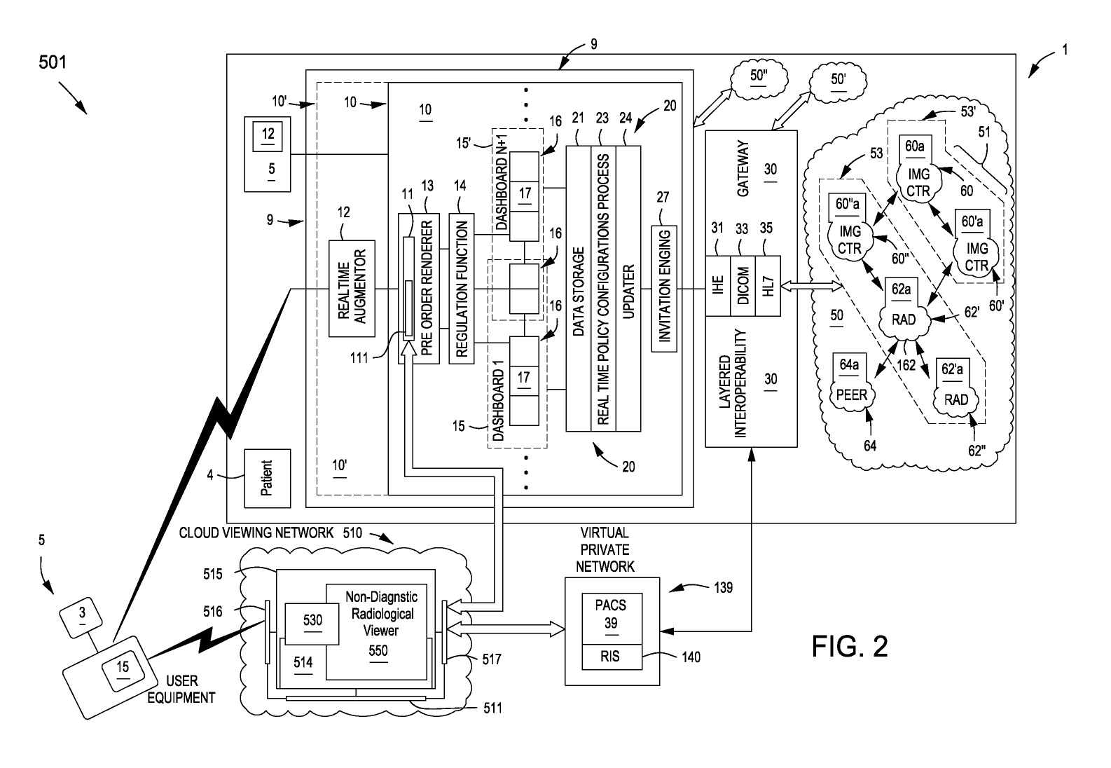

Similarly, a preorder radiology workflow initiator 622 engages a workflow application function communicatively connected to the tooling module 530 and the non-diagnostic radiological viewer 550. The preorder radiology workflow initiator 622 launches methods for preorder radiology workflow executed by the viewing system 501 of FIG. 2, such as, among others, including methods of US Patent Application Publication No. US2012/0116815A1 (May 10, 2012) to Douglas K. Smith, hereby incorporated by reference although can be applied to any medical field. In one embodiment, the preorder radiology workflow initiator 622 comprises an ERXRAY or “eRx_{ray}” brand preorder radiology workflow initiator provided by Musculoskeletal Imaging Consultants, LLC of San Antonio, Tex.

The tooling module 530 includes a multimedia conferencing tool 535. Operatively, the multimedia conference tool 535 facilitates among others screen sharing, text, photo, video, and voice communications during a consultation sequence. In one embodiment, the multimedia conference tool 535 is based on HTML5 standard protocols. Alternatively, the multimedia conference tool 535 is based on SIP standard protocols. Optionally, the tooling module 530 includes a transcription tool 537 communicatively connected to the multimedia conferencing tool 535. In operation, the transcription tool 535 provides a written digital transcription of the consultation session as shown.

As a further option, the tooling module 530 provides a feedback interface 811. Discussed in detail below, the feedback interface 811 collects and receives data for a radiologic referral social network. In one embodiment, the feedback interface 811 comprises an “eRATE” brand software application provided by Musculoskeletal Imaging Consultants, LLC of San Antonio, Tex. although can be applied to any medical field.

Shown in FIG. 7-8, the tooling module 530 includes an update function 566. The update function 566 assigns a government regulation-compliant metadata stamp with each marking as well as each recorded entry made by each user during a consultation session sequence. In one aspect, the metadata stamp is assigned by the update function 566 with each marking, including, among others, each manipulation and edit of the viewbox display image 554′ rendered on the remote file viewbox 560. Each regulatory-compliant metadata stamp assists with ePHI compliance with respect to the specific activity of each authorized user during the consultation session sequence.

Optionally, with the annotator tool 532, the consultation session can be appended as an addendum to the official report of the responsible or “signing” physician for each patent's record, such as among others a final radiologists report, via an annotator tool 539 provided by the tooling module 530. As shown, during the consultation session the authorized users collaborate regarding what content to append to the signing physician's report, such as among others an official radiology report. In one aspect, the signing physician applies personal, professional deference to the proposed appended content including annotations provided by the annotator tool 532 before appending the content as an addendum upon signing-off on the official report but is not obligated to enter at least part of the proposed content as an addendum to the official report. In one exemplary embodiment, the appended content and the official report are saved on the EMR system 139 before the content is deleted from the cloud viewing system 510 as with all information, including ePHI, acquired during a consultation session or login session. As part of the proposed content toward an addendum to a physician's official report, the annotator tool 532, shown in the exemplary embodiment of FIG. 7, provides specific instructions offered by the signing physician, such as the radiologist, regarding at least one future examination to be conducted on the patient of the official report. However, if not appended to the report, the proposed addendum content is deleted from the cloud viewing system 510. As a further option, the tooling module 530 includes an a lock-command feature for deactivating the editor tools and, optionally, the tooling module 530 as the reviewing physician, such as among others a radiologist, affixes a signature to the official report, such as among others a radiologists report, to prevent appending further content including annotations to the official report in compliance with government regulations.

Referring to FIGS. 5-13, the tooling module 530 includes a favorites interface 607. As a tool, the favorites interface 607 provides a real-time display of the most frequently accessed authorized users by the requesting user while logged into the viewing system 501 and, optionally, provides a real-time display of the viewing system's 501 most frequently accessed authorized users. Illustratively, a referring physician 3 relies on the favorites interface 607 to provide workflow metrics as to what authorized users to the viewing system 501 are most used in real-time by the referring physician user 3. In other words, the favorites interface 530 provides a compiled list of individuals that the referring physician frequently relies on to successfully accomplish a project.

In operation, the favorites interface tool 607 can be combined with the network status social media indicator 855. In the continuing illustration, the referring physician as a user 3 determines, with the combination of the favorites interface tool 607 and the network status social media indicator 855, the real-time network status of that referring physician's most relied-on individuals within the viewing system 501 in the context of workflow.

Similarly, as shown in FIG. 16, the tooling module 530 further provides a workflow distribution navigator 856. The workflow distribution navigator 856 applies a capacity algorithm to all users of the viewing system 501 to quantify each user's 3 workflow capacity in real-time or, alternatively, near real-time. FIG. 16 shows the workflow distribution navigator 856 communicatively connected to a collaborative professionals list 841 and, optionally, the network status social media indicator 855. In operation, the workflow distribution navigator 856 provides the workflow capacity of each user on the collaborative professionals list 841 whereas, optionally, the network status social media indicator 855 provides corresponding real-time network status of each individual listed user as shown.

With further reference to the cloud viewing network 510 of FIG. 1, a frontend module 516, a backend module 517, and a Software as a Service (hereinafter “SaaS”)/Platform as a Service (hereinafter PaaS) module 514. The frontend module 516 and backend module 517 are each communicatively connected to the non-diagnostic viewer 515. In one embodiment, as shown, the frontend module 516 and backend module 517 are each communicatively connected to the non-diagnostic viewer 515 at the SaaS/PaaS module 514.

As a matter of cloud-based architecture, the frontend module 516 is a layered cloud-based application communicatively connected with the non-diagnostic viewing module 515, the SaaS/PaaS module 514, and the user equipment 5. In operation, as opposed to indirect login access through a software download, such as among others a web browser of a type well known in the industry that retains user information such that the information remains on the user equipment after the login session, the SaaS/PaaS module facilitates operation of the cloud viewing network 515 on a cloud-based architecture such that the user equipment 5 directly interfaces with the frontend module 516 of the cloud viewing network 510 while communicatively connected through the internet with the user equipment 5 such that information including ePHI does not remain on the user equipment 5 when logging-off from the viewing system 501. Inasmuch, the non-diagnostic viewing module 515 provides at least one dashboard 15 as a graphical user interface for a operating the non-diagnostic viewing module 515. In one embodiment, as shown, the at least one dashboard 15 provided by the cloud viewing network 510 is accessed with user equipment 5. Operatively, each user 3 directly interfaces with the cloud viewing network 510 with at least one dashboard 15 that is accessed on user equipment 5 such that the user equipment 5 does not permanently store any data such as ePHI and other sensitive information after each session with the cloud-viewing network. The frontend module 516 and the SaaS/PaaS module 515 facilitate, at least in part, authentication and authorization of each user 3 requesting access to the viewing system 501.

Similarly, the backend module 517 is a layered cloud-based application to communicatively connect with the SaaS/PaaS module 514 and the EMR system 139. The backend module 517 and the SaaS/PaaS module 515 facilitate, at least in part, interoperability with the EMR system 139. For the embodiment of FIG. 1, the EMR system 139 is communicatively connected to the cloud viewing network 510 with a real-time HL7 interface 739 at the backend module 517.

Referring now to FIG. 2, a viewing system 501 is communicatively connected to a radiology social network referral system 1. In one embodiment, the viewing system 501 is a software application function that interfaces with radiology social network referral system 1 and any other healthcare network. The radiology social network system 1 of U.S. Patent Application Publication No. US2012/0116815A1 (May 10, 2012) to Douglas K. Smith is hereby incorporated by reference.

In particular, the radiology social network referral system 1 includes a health administration server 9 for generating user-specific dashboards 15. The viewing system 501 features a cloud-based non-diagnostic viewing module 515 communicatively connected to the health administration server 9. The health administration server 9 in one embodiment includes a regulation function that generates at least one dashboard 15. Each dashboard 15 generated by the radiology social network referral system 1 includes and displays at least one user interface component for operating the secured, cloud viewing network 510.

Operatively, the cloud-based non-diagnostic viewing module 515 provides a venue for secured synchronous and asynchronous consultations sessions for authorized users 3 while in compliance with government regulations including regulations regarding ePHI. Such consultations sessions, optionally, include viewing of non-diagnostic medical imaging files, such as non-diagnostic PACS image files, while in compliance with government regulations regarding ePHI. In operation, all digital content including non-diagnostic medical imaging files and consultation sessions is displayed on the cloud viewing network 510 as the cloud viewing network is accessed by user equipment 5 but the digital content is not permanently stored on the user equipment 5 in compliance with ePHI regulations among others. In one exemplary embodiment, all digital content including non-diagnostic medical imaging files and consultation sessions are deleted by the cloud viewing network 510 at the end of a predetermined period, such as at the end of a consultation session and login session, so that no content remains on the cloud viewing network 510 as the cloud viewing network is provided as any combination of a Software as a Service and/or Platform as a Service software application(s). In one exemplary embodiment, the content from the cloud viewing network 510, such as among others non-diagnostic medical imaging files (including non-diagnostic PACS imaging files) and consultation sessions, are stored prior to deletion by the cloud viewing network 510 in memory within the EMR system 139 or any well known Storage as a Service software application that will satisfy the government requirements for storing ePHI.

FIG. 2 shows a viewing system workframe application function 111 provided with each patient preorder workfile 11 to operate the viewing system 501 through the health administration server 9. Accordingly, dashboards 15 arising from each patient preorder workfile 11 include, among others, consultation session applications as well as access to non-diagnostic PACS and other medical imaging files. With the backend module 517, the viewing system workframe application function 111 ensures, in part, interoperability of the radiology social network referral system 1 and that the correct individual requesting medical files is authenticated with the authentication and authorization module 511 that is communicatively connected to the SaaS/PaaS module 515 as shown. In one alternative embodiment, the correct individual requesting medical files is authenticated with an ePHI compliant gatekeeper system of U.S. patent application Ser. No. ______ entitled “An ePHI-compliant Gatekeeper System and Methods” to Douglas K. Smith whereby the ePHI compliant gatekeeper system is a cloud-based service entity for verifying authentications and authorizations to the viewing system 501. Accordingly, the ePHI compliant gatekeeper system is communicatively connected with the SaaS/PaaS module 515 to provide cloud-based authorization and authentication services for the viewing system 501.

The viewing system workframe application function 111 ensures that the authenticated individual currently has the appropriate authorizations with the SaaS/PaaS module 515 to access medical information that is stored in the EMR system 139 and a radiologic referral social network 50 of the radiology social network referral system 1. Optionally, as discussed above, the medical information stored in the EMR system 138 is temporarily displayed on the cloud viewing network 510 before being deleted from the cloud viewing network 510 after a predetermined period.

Referring now to FIGS. 5, 11-22 generally illustrate at least one dashboard 15, among others, for interfacing with the viewing system 501. FIGS. 5, 11-22 generally illustrate, among others, dashboards for medical consultation, dashboards for radiological consultations, dashboards for providing a network status social media indicator, and dashboards for accessing non-diagnostic PACS image files.

FIG. 5 is a schematic diagram of a graphical user interface of at least one dashboard 15 for a operating the non-diagnostic viewing module illustrating a master authorized user dashboard 600. If set as a homepage dashboard, in one aspect, a requesting user 15 logins into the viewing system 501 and first accesses the viewing system's 501 the master authorized user dashboard 600.

The master authorized user dashboard 600 includes an alert notifications interface 601 that displays significant changes relating to the requesting user 3, shown as a radiologist, for immediate attention. A communications summary interface 603 comprehensively lists digital files of past communications sessions for reference by the requesting user 3. The communications summary interface 603 provides a hyperlink to access each stored digital file. Optionally, in one exemplary embodiment, the digital file may be stored in memory that is external to the cloud viewing system 510 such as among others the EMR system 139 or Storage as a Service cloud-based entity.

A user profile interface 603 provides information regarding the requesting user 3 such as personal information relating to the radiologist in the illustration such as photo, resume, contact information and employing entity for the radiologist in this account. Those of ordinary skill will recognize that the same radiologist can have different user accounts with the viewing system 501 for different employing entities. Alternatively, as shown, the radiologist can have a single user account with the viewing system 501 despite working for many different entities. An employing entity status profile 605 indicates the employing entity of the radiologist for the current login session by which the information on the master authorized user dashboard 600 is shared by the employing entity and the profiled user 3, i.e. the radiologist in the continuing illustration.

The master authorized user dashboard 600 includes a workflow interface 609. As shown the workflow interface 609 comprehensively lists the work projects personally assigned to the requesting user 3, i.e. the illustrated radiologist, that are provided by the employing entity, Musculoskeletal Imaging Consultants, LLC.

In general, FIGS. 11-13 illustrate graphical user interfaces for operating the non-diagnostic viewing module 515 with at least one dashboard that is configured for use by medical patients. FIG. 11 illustrates a patient homepage dashboard 800 collectively providing a comprehensive directory listing 803 of all official reports, such as final radiologist reports, for a single medical patient.

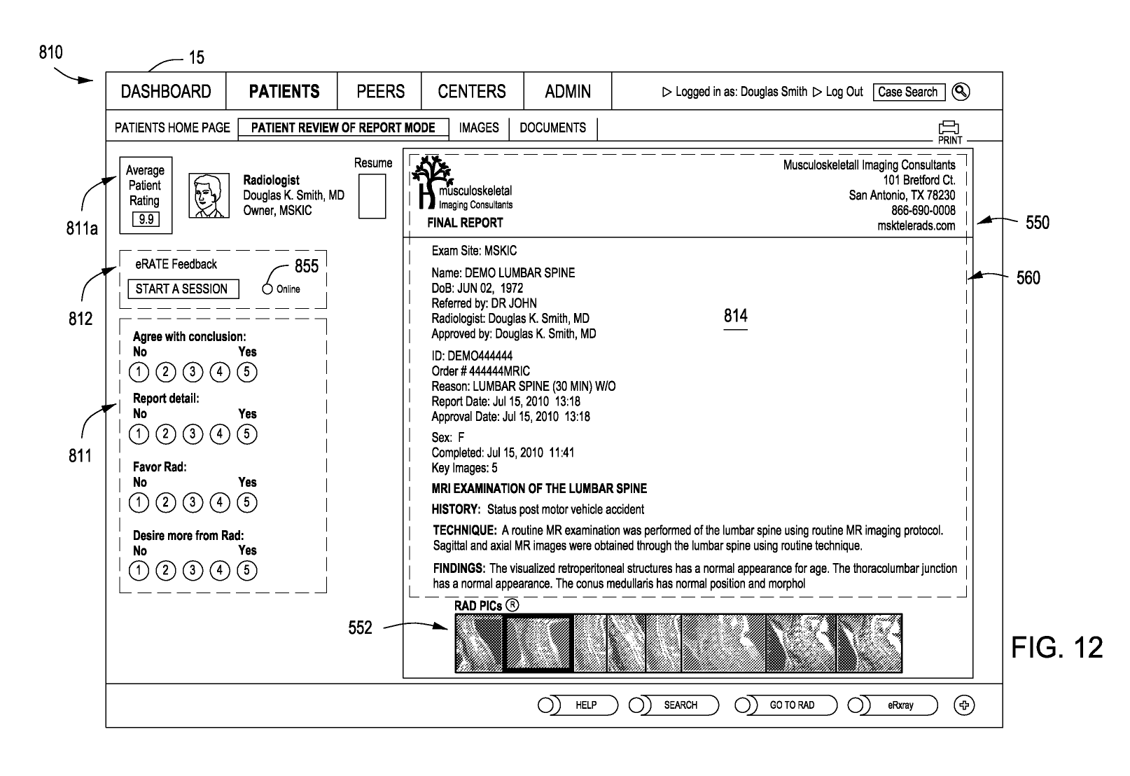

FIG. 12 shows a patient review dashboard 810. The patient review dashboard 810 includes a reporting physician profile 811a personally assigned to the illustrated patient including a social network feedback rating of the reporting physician and conference session initiator 812 for the reviewing user to access. The patient review dashboard 810 includes a feedback interface 811 for rating and reviewing each radiologist report provided to the patient. While in operation, the patient review dashboard 810 continues to display information to a physician via the remote file viewbox 560 although, specifically, an authorized physician is redirected from the cloud-based viewing module 515 to a radiologic referral social network 1 that stores an official radiologist report 814 for detailed viewing of the master official report on the non-diagnostic viewing module 515. A cloud viewing network dashboard is shown in FIG. 13 as displaying a non-diagnostic PACS image file 554.

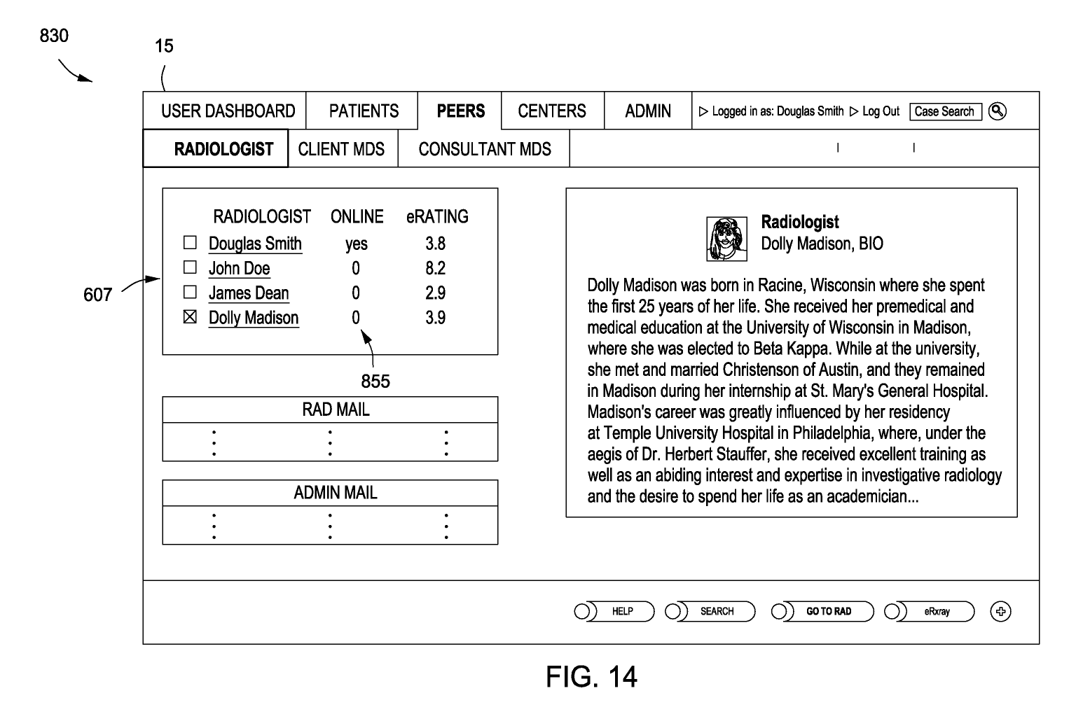

FIGS. 14-16 illustrate graphical user interfaces for operating the non-diagnostic viewing module 515 with at least one dashboard 15 for peers that collaborate on patient work with the authorized user. For example, a peer is a medical professional with the same professional background as the authorized user 3, such as a fellow radiologist, cardiologist etc.

FIG. 14 shows a peer profile dashboard 830 for an authorized user 3, for example the radiologist Douglas Smith of FIG. 5 as the authorized user. The peer profile dashboard 830 displays the radiologist Dr. Smith's fellow radiologist coworkers or “peers” as a graphical user interface including, among others, the profiles of each peer, the favorites interface 607, and social media indicators such as network status of users of the viewing system 501 as well as corresponding ratings and reviews of each peer user as shown. In one aspect, in the continuing example, the peer profile dashboard 830 refers to those users having the same role as a radiologist as opposed to users having a similar role as any licensed physician such as an orthopedist, surgeon, and podiatrist. Operatively, in the continuing illustration, the favorites interface 607 provides a real-time display of radiologist Dr. Smith's authorized peer users that are most accessed by him within the viewing system 501 and, optionally, provides network status social media indicator 855 to assist Dr. Smith in determining what authorized peer users are currently available during Dr. Smith's login session with the viewing system 501, such as for a consultation session as discussed in detail below.

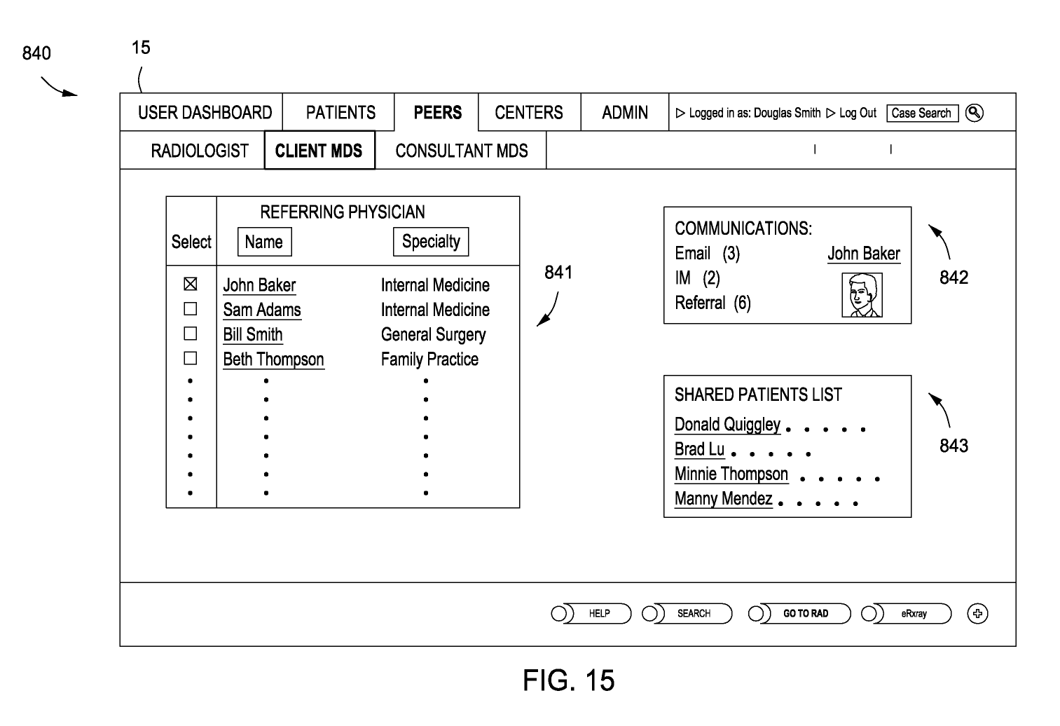

FIG. 15 shows a work-providing physician peer dashboard 840 for an authorized user, for example the radiologist Douglas Smith of FIG. 5 as the authorized user. The work-providing physician peer dashboard 840 displays a network list of work providing physicians to Dr. Smith also referred to as “referring physician's” or “Client MDs” network list, the work-providing physician's profiles, and further displays a “Shared Patients” list of assigned patients that are shared by the radiologist, Dr. Smith and Dr. Smith's work-providing physicians or “Client MDs”. Those of ordinary skill will recognize that any work-providing physician assigns work to Dr. Smith as Dr. Smith assumes different employment roles such that for example the work-providing physician can either directly employ the radiologist Dr. Smith or any work-providing physician from a clinic or hospital system can also provide work to the radiologist Dr. Smith.

A shared patient interface 843 displays a list of patients whereby each patient provides a work assignment that is shared by both the authorized user radiologist and authorized work-providing peer users such any physicians providing work to the radiologist that often have a similar role to as a physician but not typically an identical role as radiologist in the continuing illustration. Operationally interfacing with the list of user patients on FIG. 15, in one exemplary embodiment, will direct the non-diagnostic viewing module 515 to display the medical patient dashboards of FIGS. 11-13 by means for hyperlinking.

FIG. 16 shows a consultant physician peer dashboard 840 for an authorized user, for example the radiologist Douglas Smith of FIG. 5 as the authorized user. In this disclosure the term “consultant physician” refers to a physician that collaborates on work projects but is typically not in the same medical field or specialty as the authorized user. Referring to FIGS. 16 and 5, for example, a consultant physician, an orthopedist James Black, collaborates with the authorized user, radiologist Dr. Smith, on a work assignment for a patient with a shattered leg from a motorcycle accident, Brad Lu.

The consultant physician peer dashboard 840 includes, among others, a “Consultant MDs” network list 841 of those physicians that the radiologist collaborates with on radiology orders for patients as well as a network status social media indicator 855 for the referring physician to view with respect to real-time availability of collaborating physicians. For the embodiment of FIG. 16, the network list 841 features a network status social media indicator 855 and a workflow distribution navigator 856. Moreover, a communications interface 842 provides, for each selected individual from the network list 841, contact information and a summary of communications with respect to the selected individual.

In FIG. 16, as orthopedist James Black is selected from the network list 841 of the continuing illustration, James Black's information appears on the communications interface 842 of the consultant physician peer dashboard 840. Optionally, in one exemplary embodiment, interfacing with the communications interface 842 on FIG. 16 will direct the non-diagnostic viewing module 515 via hyperlinking application 842a to the communications summary interface 603 of the master authorized user dashboard 600 of FIG. 5 for a comprehensive list of all past communication sessions in addition to those of James Black for the radiologist Dr. Smith to review.

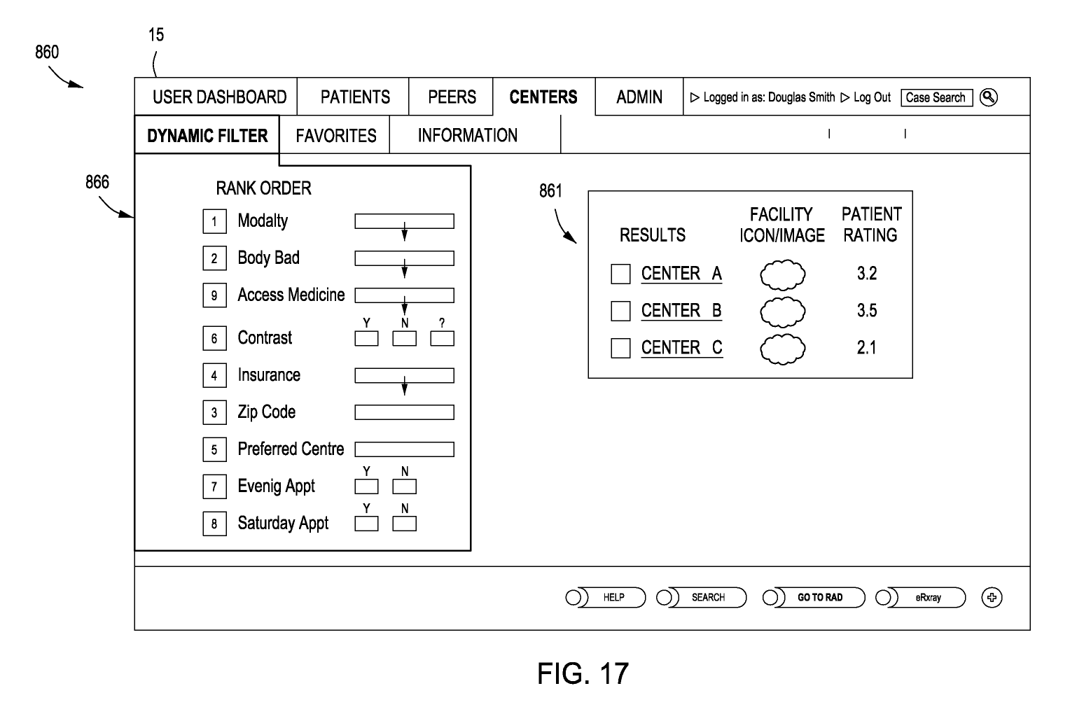

FIGS. 17-19 illustrate graphical user interfaces for operating the non-diagnostic viewing module 515 with at least one dashboard 15 for medical imaging centers that collaborate on patient work assignments with the authorized user. FIG. 17 shows medical imaging center selection dashboard 860 for an authorized user, for example the radiologist Douglas Smith of FIG. 5 as the authorized user. Those of ordinary skill in the art will readily recognize that the aspects provided in the medical imaging center selection dashboard 860 can be applied for any vendor selection by the authorized user in addition to the illustrated medical imaging centers.

Specifically, the medical imaging center selection dashboard 860 displays at least one selection set provided by filter tools 866 for choosing an imaging center from a list updated in real-time. Based on the input received from the at least one selection set provided by filter tools 866, the medical imaging center selection dashboard 860 includes a vendor search results interface 861 providing at least one selection set of imaging centers based on the received input. In one exemplary embodiment, at least one selection set provided by the filter tools 866 is based on shared information obtained from the radiology social network referral system 1 as discussed in US Patent Application Publication No. US2012/0116815A1 (May 10, 2012) to Douglas K. Smith, hereby incorporated by reference. In one exemplary embodiment, at least one selection set provided by the filter tools 866 is based on policy configurations obtained from the radiology social network referral system 1 as discussed in US Patent Application Publication No. US2012/0116815A1 (May 10, 2012) to Douglas K. Smith, hereby incorporated by reference.

As shown, at least one selection set displayed on the vendor search results interface 861 includes icons or images for identifying each selected imaging center. The vendor search results interface 861a linking tool, illustratively shown in FIG. 17 as a hyperlink, for directing the non-diagnostic viewing module 515 to launch methods for preorder radiology workflow provided by the preorder radiology workflow initiator 62 discussed above, including methods of US Patent Application Publication No. US2012/0116815A1 (May 10, 2012) to Douglas K. Smith, hereby incorporated by reference.

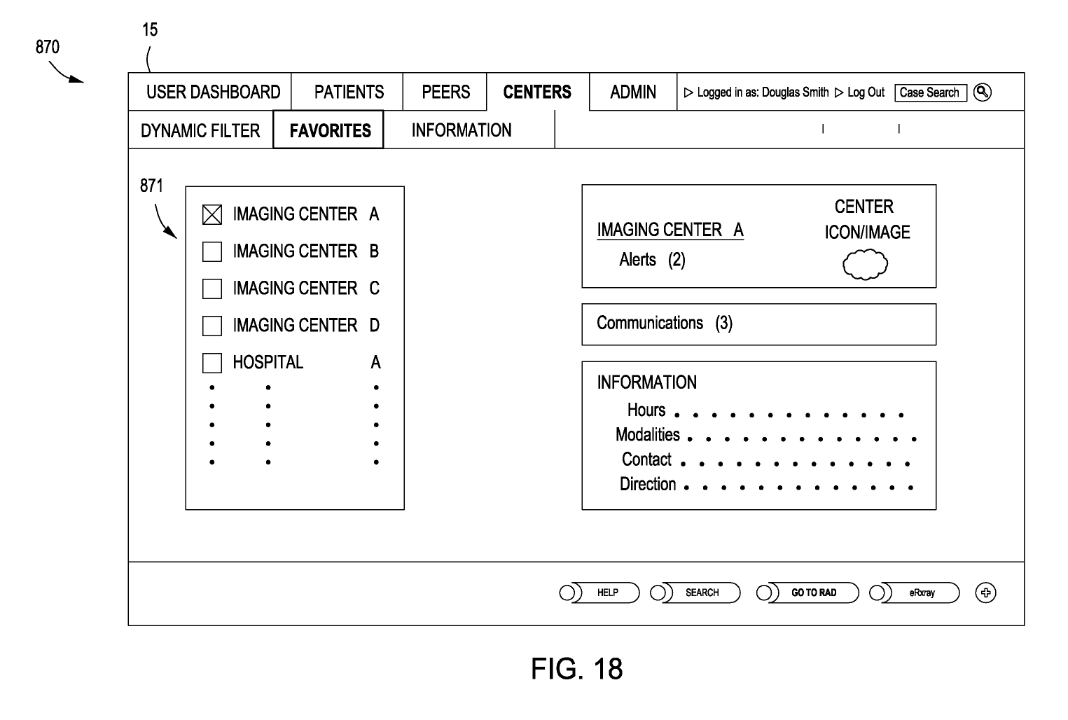

FIG. 18 shows a favorite imaging center dashboard 560 that includes a favorites interface 607 that displays, in real-time, a list of the authorized user's (the radiologist Douglas Smith in the continuing illustration of FIG. 5) most accessed imaging centers as authorized users to the viewing system 501. Optionally, the favorites interface 607 displays the viewing system's 501 most accessed imaging centers that includes Dr. Smith's most accessed imaging centers. In one embodiment, a list of favorite imaging centers is based on shared information from the radiologic referral social network 1.

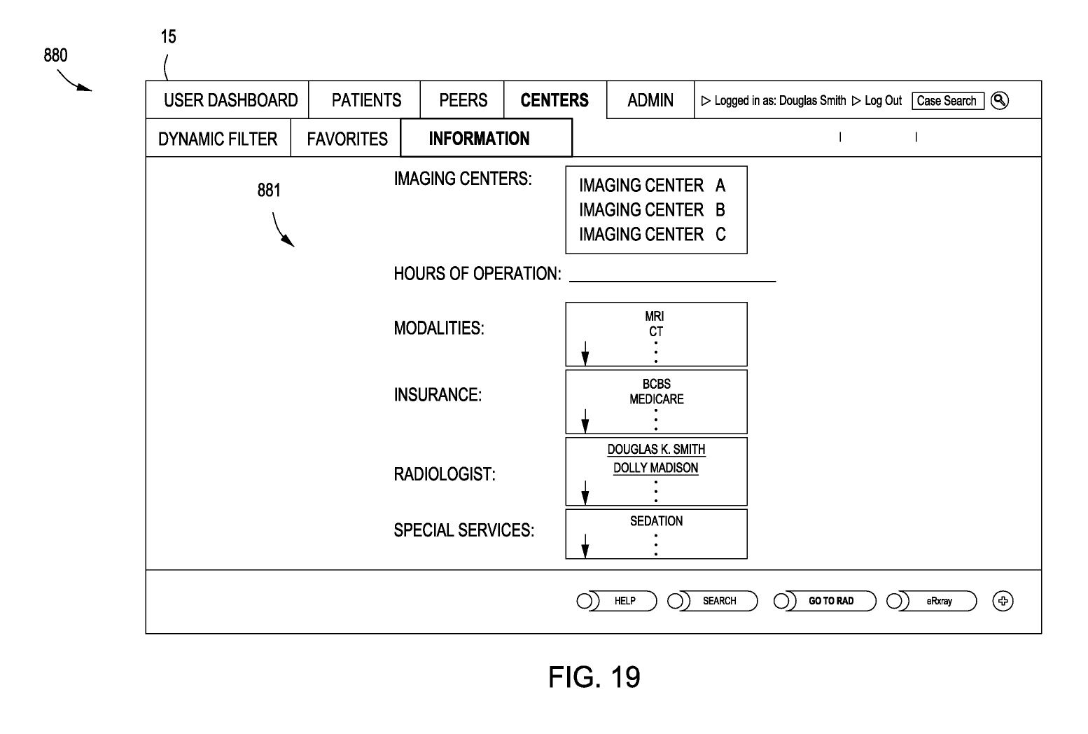

FIG. 19 is a schematic diagram of a medical imaging center profile dashboard 880. The medical imaging center profile dashboard 880 displays a detailed information profile 881 of an imaging center selected from a list of imaging centers updated in real time and provided by the vendor search results interface 861 of the medical imaging center selection dashboard 860 of FIG. 17 or, alternatively, the favorites interface 607 of the favorite imaging center dashboard 560 of FIG. 18.

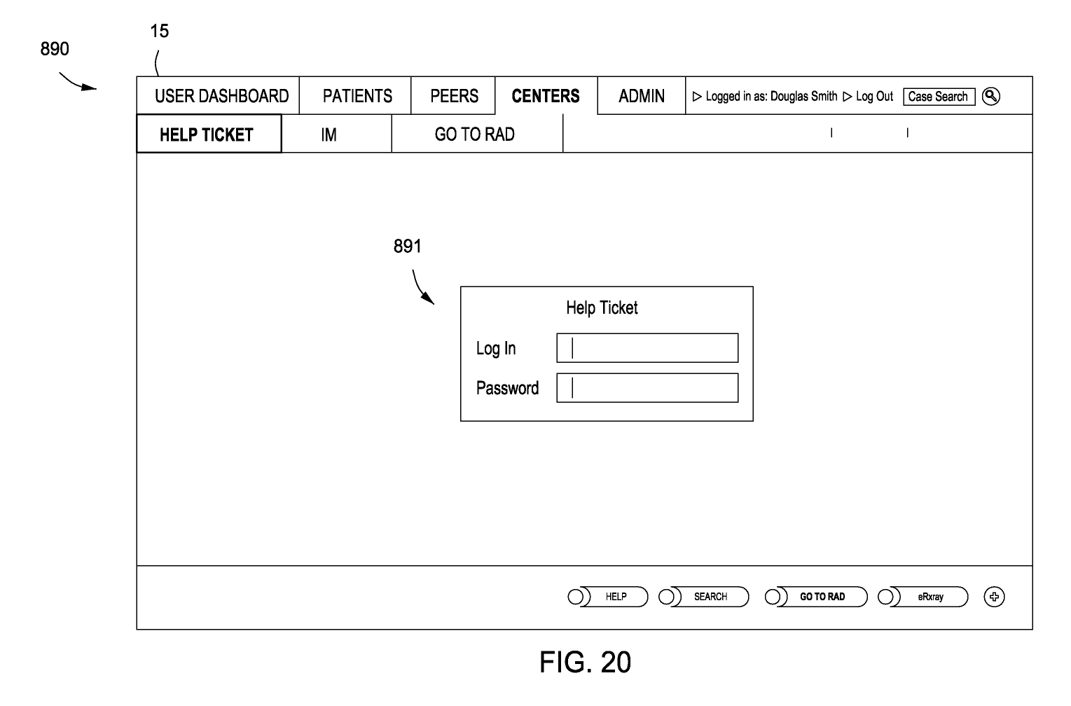

FIGS. 20-22 illustrate graphical user interfaces for operating the non-diagnostic viewing module 515 with at least one dashboard 15 provide network service tools for the authorized user to interface with a network administrator that operates the cloud-based, viewing system 501. FIG. 20 shows a HELP cloud viewing network service tool dashboard 890. The HELP cloud viewing network service tool dashboard 890 includes a HELP interface tool 891. The HELP interface tool 891 initiates a help request sequence. The help request sequence includes a help request sent by an authorized user to a network administrator that operates the viewing system 501. Optionally, the help request sequence sends a system email from the authorized user to another authorized user that is currently logged-off from the cloud viewing network 510 thereby prompting a reply by the logged-off user by first logging-in to the viewing system 501.

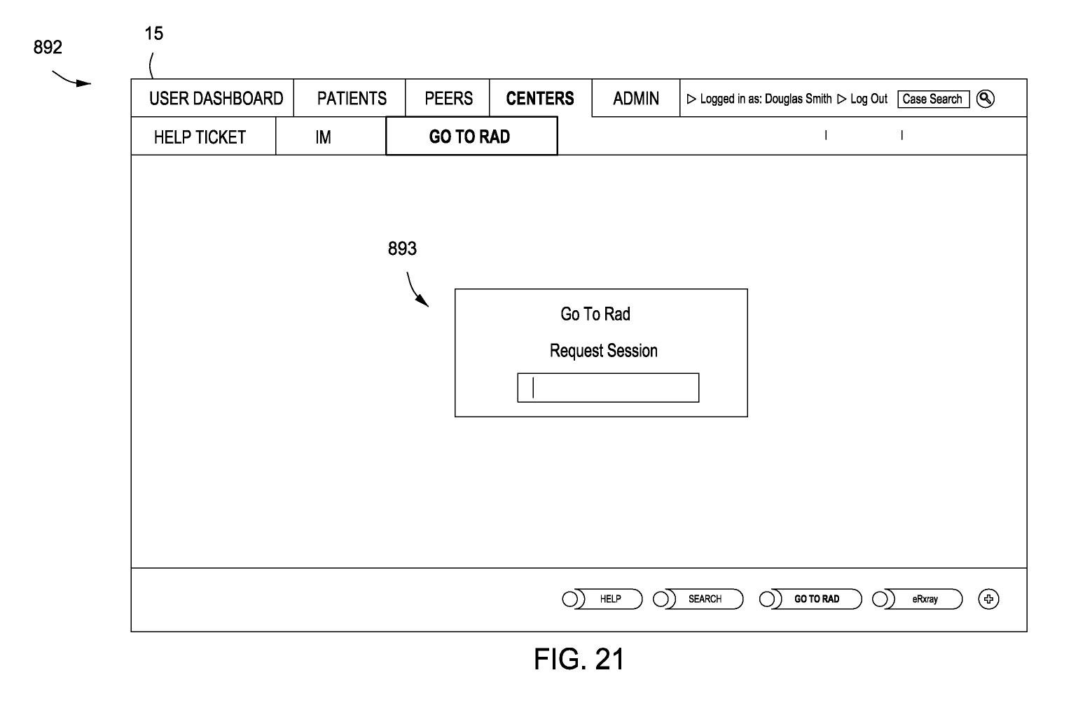

FIG. 21 shows a RADIOLOGIST HELP cloud viewing network service tool dashboard 892. The RADIOLOGIST HELP cloud viewing network service tool dashboard 892 is linked to the consultation session initiator 620, described above, to engage a consultation session software application function for initiating a cloud-based consultation session sequence, such as requesting a consultation session with a radiologist. In particular, the consultation application function includes methods of radiological consultations as described in detail below. In one embodiment, the consultation session initiator 620 comprises a GO TO RAD brand consultation session initiator provided by Musculoskeletal Imaging Consultants, LLC of San Antonio, Tex.

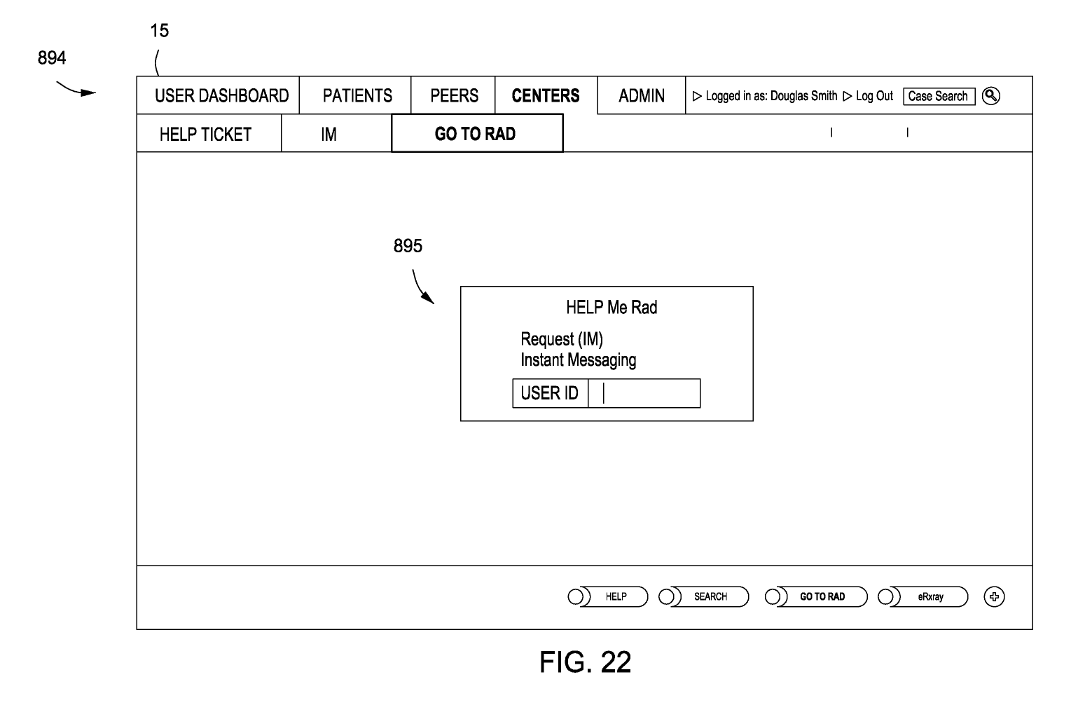

FIG. 22 shows a RADIOLOGIST IM HELP cloud viewing network service tool dashboard 895 that is a specific instance of the RADIOLOGIST HELP cloud viewing network service tool dashboard 892 of FIG. 21. The RADIOLOGIST IM HELP cloud viewing network service tool dashboard 895 initiates a user request for help from a radiologist by engaging an instant messaging sequence between the requested authorized user and a desired radiologist.

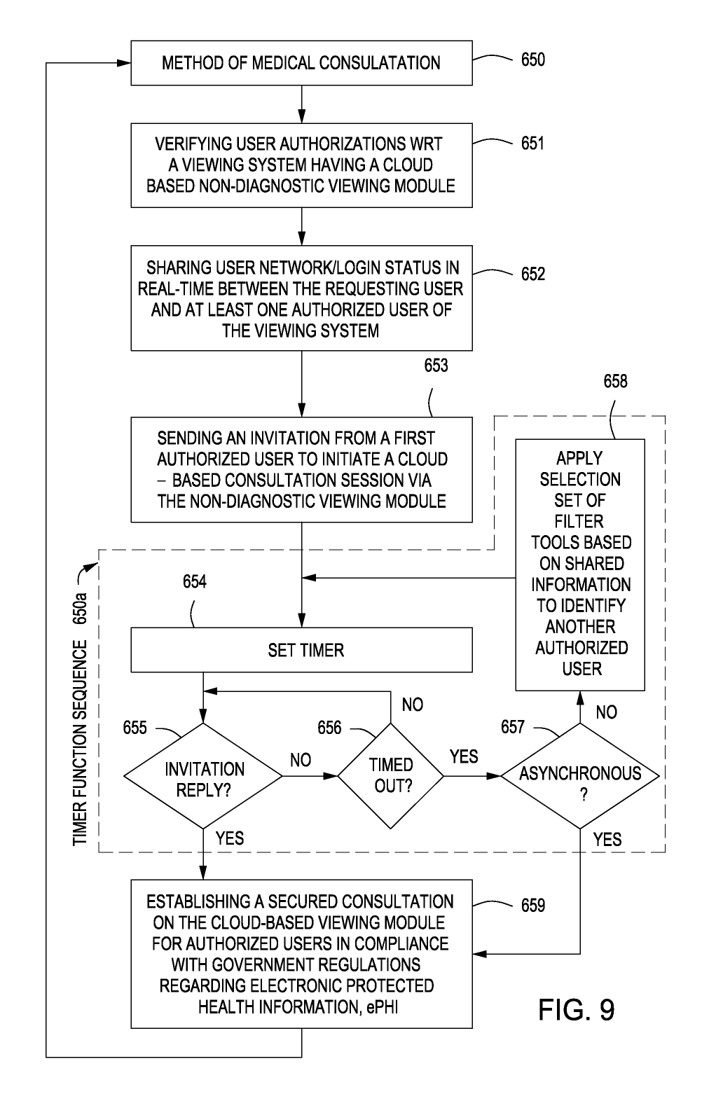

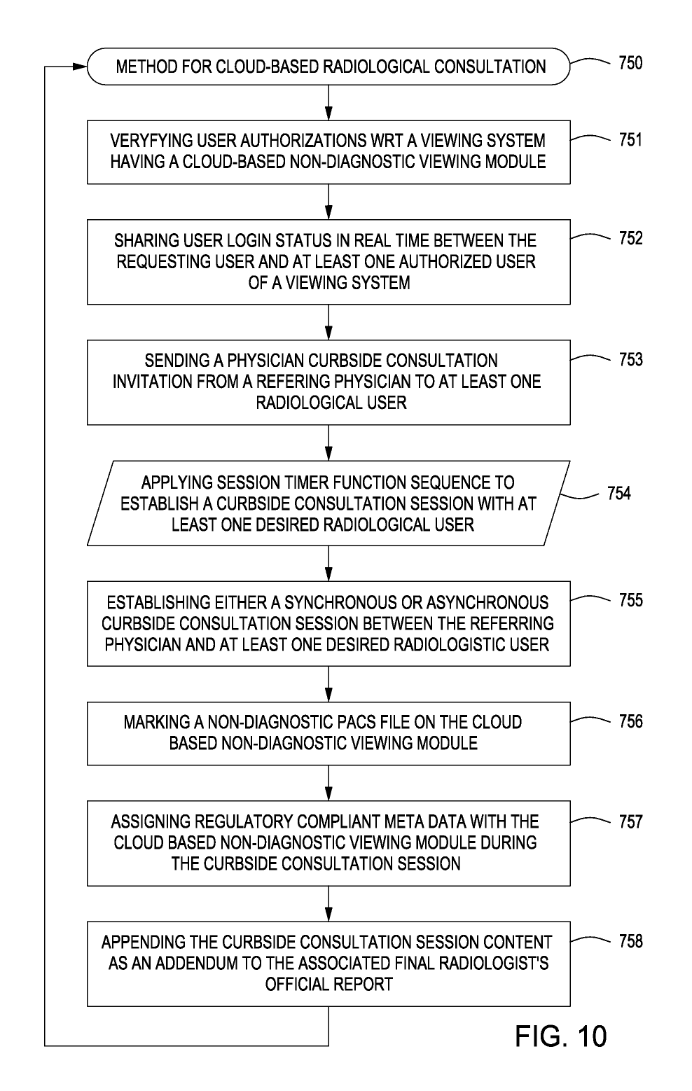

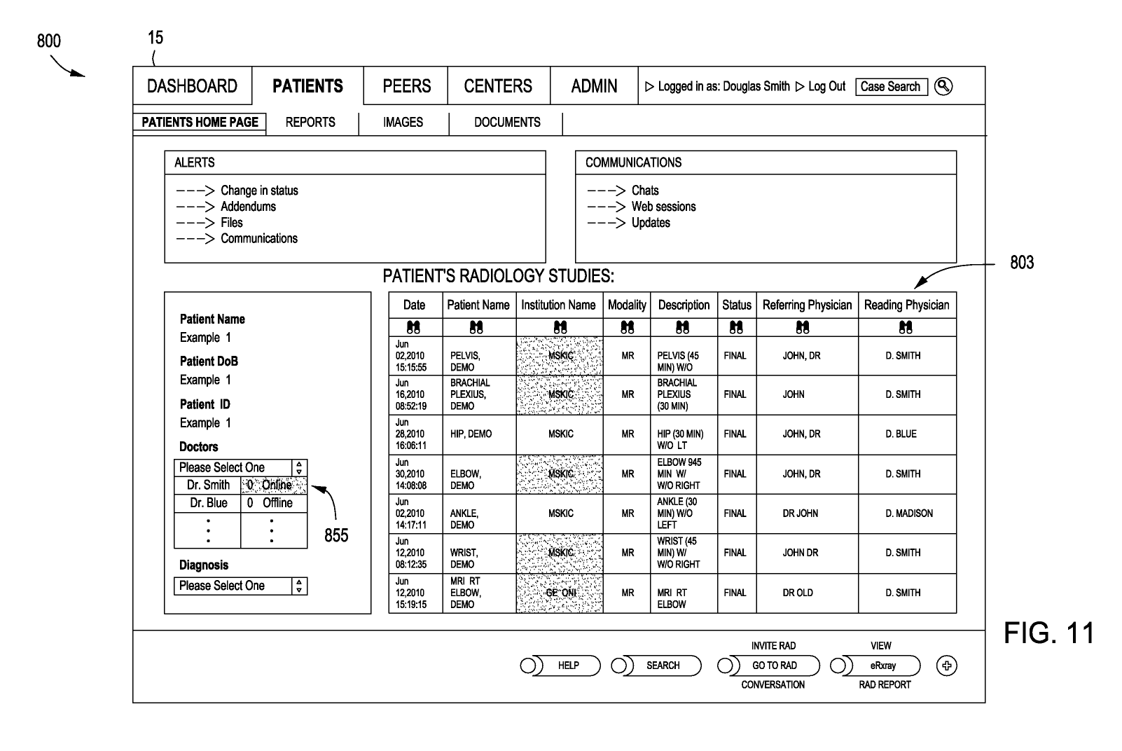

Referring now to FIGS. 9 and 10, methods for establishing a cloud-based medical consultation session 650 and a cloud-based radiological consultation 750, respectively, among authenticated and authorized users to the viewing system 501 are appreciated as follows. Generally, based on the authorized role of the requesting user 3, the non-diagnostic viewing module 515 provides a secure, cloud-based venue for either a synchronous or an asynchronous consultation session with at least one authorized user of the viewing system 501. Illustratively, a consultation session is established between a referring physician and a radiologist, both authorized by the viewing system 501 with respect to government regulations, to briefly address some questions with a mobile device, as user equipment 5, while the corresponding patient remains in the exam room. Those of ordinary skill in the art will readily recognize other applications for establishing a cloud-based medical consultation session 650 and a cloud-based radiological consultation 750.

The network status social media indicator 855 assists the requesting user while interfacing on the at least one dashboard 15 to determine what authorized users are currently available on the viewing system 501 for a brief synchronous consultation session or to, alternatively, provide questions and comments asynchronously through the non-diagnostic viewing module 515 to a desired user that is not presently available for a consultation session. In one embodiment, the consultation session initiator 620 triggers methods for medical consultation 650 and methods for radiological consultation 750. It should be added that the non-diagnostic viewing module 515 optionally facilitates a multimedia conference, via the multimedia conferencing tool 535, and provides non-diagnostic PAC image files as derived from diagnostic PACS image files from the EMR system 139 thereby to quickly and securely gain perspectives during any consultation session while in an exam room with the corresponding patient.

Referring to FIG. 9, a method for establishing a cloud-based medical consultation session 650 is appreciated as follows. A user that is requesting access to the viewing system 501 as described above, hence “requesting user”, interfaces with user equipment 5, such as a mobile device, to provide the required login information by interfacing with the at least one dashboard 15. In step 651, the viewing system 501 with a cloud-based non-diagnostic viewing module 515, verifies in real-time user authorizations of the requesting user and verifies in real-time user authorizations for each user 3 participating with the viewing system 501 in real-time. In one aspect, the viewing system 501 with a cloud-based non-diagnostic viewing module 515 verifies user authentications of the requesting user in real-time and verifies user authentications for each user 3 participating with the viewing system 501 in real-time. In one exemplary embodiment, the viewing system 501 is communicatively connected with an ePHI compliant gatekeeper system of U.S. patent application Ser. No. ______ entitled “An ePHI-compliant Gatekeeper System and Methods” to Douglas K. Smith whereby the ePHI compliant gatekeeper system is a cloud-based service entity for verifying authentications and authorizations to the viewing system 501.

The login or “network” status of each user is shared in real-time with all users that are authorized to participate within the viewing system 501. In one aspect, only a subset of all users is authorized by the viewing system 501 to establish a cloud-based medical consultation session. At least one authorization of the viewing system 501 among others is based on occupational roles that define each user of the viewing system 501 such that the degree to which the requesting user interfaces with at least one authorized user depends at least in part on the each occupational role shared between the requesting user and the at least one authorized user. Accordingly, for example, authorizations by the viewing system 501 are set in compliance with government regulations regarding electronic protected health information as well as set based on shared authorized roles between the requesting user and at least one authorized user, such as shared National Provider Identifier, NPI, authorizations.

Illustratively, in one embodiment, role-based authorizations determine those users that are permitted to establish a cloud-based medical consultation session. For example, with respect to a commonly assigned patient, one role-based authorization includes medical professionals that have each previously received a signed HIPAA consent form from their commonly assigned patient prior to initiating a medical consultation session regarding the shared patient by interfacing with the cloud-based non-diagnostic viewing module 515 through the at least one dashboard 15 displayed on respective user equipment 5.

With reference to FIG. 9, user “login status” or “network status” is shared in real-time, at step 652, between the requesting user and at least one authorized user of the viewing system 501. At step 652, on successful verification of authorizations with the viewing system 501, the requesting user receives user network status of at least one authorized user of the viewing system 501 that is authorized to establish a medical consultation session to communicate with the requesting user through at least one viewing system dashboard 15 displayed on respective user equipment 5 such as mobile devices.

In step 653, the cloud-based, non-diagnostic viewing module 515 facilitates sending an invitation to initiate a cloud-based, medical consultation session. In particular, a first authorized user sends an invitation for a consultation session to at least one user of the viewing system 501 that is authorized for receiving the invitation. The first authorized user, in one exemplary embodiment, refers to the requesting user as discussed further above. The consultation session in one embodiment comprises a curbside consultation, such as, among others, a curbside consultation for physicians. In one aspect, in addition to using the non-diagnostic radiological viewer 550, the consultation session on the non-diagnostic viewing module 515 optionally includes, among others, using the multimedia conferencing tool 535, the synchronous/asynchronous communications monitor 533, the annotator tool 539, the network status social media indicator 855, and the network distribution navigator 856.

Steps 654, 655, 656, 657, and 658 collectively define a session timer function sequence 650a. By analogy, the session timer function sequence 650a allows the consultation session invitor to “knock-on-doors” for a predetermined period and either leave a question or comment for the invitee that is “not-at-home” or move-on to the next invitee until a viable selection is made by the invitor to establish the consultation session. In other words, within a predetermined period with respect to the consultation session invitation sent by the first user via the non-diagnostic viewing module 515, the session timer sequence 650a automatically locates an invitee either willing to respond synchronously, “available for live response” or “real-time” conferencing or willing to respond asynchronously, “not-available for live response” or “respond—but at another time”.

Accordingly, the session timer function sequence 650a begins at step 654 where a timer function is set for a predetermined period, such as, among others, a 10 second period, a 30 second period, and a 1.5 minute period. In step 655, the consultation session invitation is received by a second authorized user from the first authorized user. The cloud-based, non-diagnostic viewing module 515 in step 655 queries the second authorized user for a reply to the invitation request. If the second authorized user accepts the consultation session invitation request, the session timer function sequence 650a advances from step 655 to step 659. However, at step 656 the invitation request query is repeated for the predetermined period until either the second authorized user responds and accepts to advance the sequence 650a to step 659 or the predetermined period expires to alternatively direct the session timer function sequence 650a to step 657.

At step 657, the session timer function sequence 650a queries the invitor, i.e. first authorized user, whether to asynchronously leave information, such as among others questions and comments, for the second user or to advance to step 658 to select another authorized user. An asynchronous consultation session prompts the second authorized user to respond at the first opportunity to the first authorized user's questions and comments. In one exemplary embodiment, the help interface tool 891 is optionally applied at step 657 by the timer function sequence 650a to send a system email from the first authorized user to the second authorized user that is logged-off from the viewing system 501 thereby engaging a reply by the logged-off second authorized user by first logging-in to the cloud-based viewing system 501.

At step 658, the first authorized user selects another authorized user to send an invitation request for a consultation session. In one aspect, to identify another authorized user for receiving the invitation, the first authorized user uses the filter tools 866 from the tooling module 530 to derive at least one selection set of other possible authorized users for receiving an invitation based on social-networked, shared information obtained from the radiology social network referral system 1. Illustratively, the first authorized user applies a selection set of shared information to select an authorized user for receiving an consultation sequence invitation including real-time availability, real-time social network reviews, real-time social network ratings, geo-location, area of medical specialization, affiliation with a particular medical entity or hospital, acceptance of particular medical insurance or preferred provider plan, active licensure to practice medicine in particular state, and participation in health or radiology cooperative.

Accordingly, the session timer function sequence 650a moves from step 658 to step 654 to repeat the sequence. The session timer function sequence 650a is repeated until the first authorized user actively establishes, synchronously, a consultation session in response to a successful reply to the consultation session invitation by another authorized user. In one exemplary embodiment, the session timer function sequence 650a is repeated until the first authorized user establishes a synchronous consultation session in response to a successful reply to the consultation session invitation by another authorized user. The session timer function sequence 650a in one exemplary embodiment is repeated until the first authorized user actively establishes, synchronously, a consultation session or passively leaves a prompt and information for an asynchronous consultation session in response to a successful reply to the consultation session invitation by another authorized user.

Referring to step 659, the consultation session is securely established on the cloud-based viewing module 515 for authorized users in compliance with government regulations regarding electronic protected health information, ePHI. At the close of the secured session, the method of medical consultation 650 can be repeated by any authorized user. Alternatively, to add any number of authorized users to join consultation session, the method of medical consultation 650 is repeated by any authorized user during the existing consultation session. Each collaboration session on the cloud viewing network is scalable in that authorized users, such as physicians and other medical professionals, can join and leave the session as needed. In one aspect, the method of medical consultation 650 can be applied while an existing consultation session is in progress to simultaneously initiate a plurality of independent consultation sessions by authorized users. The digital files associated with the consultation session are deleted from the cloud viewing network 510 and appended to a final official physician's report before deletion. Optionally, the digital files associated with the consultation session are saved in a storage facility prior to deletion of session information including consultation sessions by the viewing system 501, such as among others as a Storage as a Service entity and the EMR system 139.

Optionally, the annotator tool 539 can be accessed during the consultation session as a tool for promoting collaboration among the authorized users to determine what content (including annotations provided by the annotator tool 539 as illustrated in FIG. 7) from the consultation session to append to the signing physician's report, such as among others an official radiology report. Accordingly, the consultation session can be appended as an addendum to a physician's official report, such as a final radiologist's report, via an annotator tool 539 provided by the tooling module 530. As a further option, the tooling module 530 includes an a lock-command feature for deactivating the editor tools provided by the non-diagnostic viewing module 515 as discussed above to prevent appending further content including annotations to the official report in compliance with government regulations.

Similarly, with reference now to FIG. 10, a method for establishing a cloud-based radiological consultation session 750 is appreciated as follows. In step 751, a user that is requesting access to the viewing system 501 as described above, hence “requesting user”, interfaces on user equipment 5, such as a mobile device, with the at least one dashboard 15 of the viewing system 501 to provide the required login information. The viewing system 501 includes the diagnostic radiology imaging system 239 and a cloud viewing network 510. The diagnostic radiology imaging system 239 includes a PACS 39. The cloud viewing network 510 includes a non-diagnostic viewing module 515. The non-diagnostic viewing module 515 includes a non-diagnostic radiological viewer 550 and a tooling module 530. The non-diagnostic radiological viewer 550 is communicatively connected to the PACS 39

In step 751, the viewing system 501 with a cloud-based non-diagnostic viewing module 515 verifies user authorizations of the requesting user in real-time and verifies user authorizations in real-time for each user 3 participating with the viewing system 501. In one aspect, the viewing system 501 with a cloud-based non-diagnostic viewing module 515 verifies in real-time user authentications of the requesting user and verifies in real-time user authentications for each user 3 participating with the viewing system 501.

The login or network status of each user is shared in real time with all users that are authorized to participate within the viewing system 501. In one aspect, only a subset of all users is authorized by the viewing system 501 to establish a cloud-based radiological consultation session. Accordingly, for example, authorizations by the viewing system 501 are set in compliance with government regulations regarding electronic protected health information as well as set based on shared authorized roles between the requesting user and at least one authorized user through at least one viewing system dashboard 15 displayed on the respective user equipment 5 such as a mobile device.

User “login status” or “network status” is shared in real-time, at step 752, between the requesting user and at least one authorized user of the viewing system 501. At step 752, on successful verification of authorizations with the viewing system 501, the requesting user receives user network status of at least one authorized user of the viewing system 501 that is authorized to establish a radiological consultation session to communicate with the requesting user.

In step 753, the cloud-based, non-diagnostic viewing module 515 facilitates sending an invitation to initiate a cloud-based, physician curbside consultation session. In particular, a first authorized user sends an invitation for a physician curbside consultation session to at least one user that is authorized for receiving the invitation. The first authorized user, in one exemplary embodiment, is the requesting user discussed above.

For purposes of illustration, in one exemplary embodiment, the first authorized user is a referring physician that provides an invitation for a physician curbside consultation session to at least one radiologist as the authorized receiving user to establish the physician curbside consultation session that is associated with the field of radiology. Those of ordinary skill will recognize that although the illustrated physician curbside consultation session is between a referring physician and a radiologist, the physician curbside consultation session can be applied to physicians from any medical field.

In one aspect, in addition to using the non-diagnostic radiological viewer 550, the physician curbside consultation session displayed on the at least one dashboard 15 by the non-diagnostic viewing module 515 optionally includes, among others, using the multimedia conferencing tool 535, synchronous/asynchronous communications monitor 533, annotator tool 539, the network status social media indicator 855, and the network distribution navigator 856.

Optionally, in step 754, the viewing system 501 applies a session timer function sequence 754 to establish a physician curbside consultation session with at least one radiological user. In one exemplary embodiment, the at least one radiological user is a radiologist. The session timer function sequence 754 is the same as the session timer function sequence 650a described above. The session timer function sequence 754 is repeated until the referring physician actively establishes a physician curbside consultation session, synchronously, or, passively, leaves a prompt and information for an asynchronous consultation session in response to a successful reply to the physician curbside consultation session invitation by at least one radiologist. As such, at step 755, either a synchronous or an asynchronous physician curbside consultation session is established between the referring physician and the at least one radiologist.

Optionally, during the established physician curbside consultation session, the referring physician and the radiologist accesses the cloud-based, non-diagnostic viewer 515 from their mobile devices to review medical image files, such as non-diagnostic PACS image files. As such, in step 756, a non-diagnostic medical image file, such as a non-diagnostic PACS image file, is marked on the at least one dashboard 15 with the tooling module 530 provided by the non-diagnostic viewing module 515 as the non-diagnostic image file is displayed on the cloud-based, non-diagnostic radiological viewer 550.

At step 758, the update function 566 provided by the tooling module 530 assigns a government regulation-compliant metadata stamp with each marking as well as each entry made by a user interfacing with each dashboard 15 provided by the viewing system 501 while participating in a physician curbside consultation session. In one exemplary embodiment, the update function 566 at step 758 specifically assigns a government regulation-compliant metadata stamp with each entry made by a user during a physician curbside consultation session, including among others each marking (including each manipulation and edit) of non-diagnostic image file displayed on the non-diagnostic radiological viewer 550. The digital files associated with the physician curbside consultation session including non-diagnostic medical image files (that further include non-diagnostic PACS image files) are deleted from the cloud viewing network 510 and appended to a final official physician's report before deletion. Moreover, the digital files are not permanently stored in the user equipment 5 that accesses the cloud viewing network 510 while in operation to view the digital files displayed on the cloud viewing network 510. As an option, the digital files associated with the physician curbside consultation session including non-diagnostic medical image files (that further include non-diagnostic PACS image files) are saved in a storage facility prior to deletion, such as among others at a Storage as a Service entity and the EMR system 139 of session information including physician curbside consultation sessions by the viewing system 501. Accordingly, in one embodiment, the non-diagnostic medical image files include non-diagnostic PACS image files that further include marked non-diagnostic PACS image files.

The tooling module 530, in step 758, provides an annotator tool 539 for appending the digital file containing the consultation session as an addendum to the related final official radiologist's report. During the physician curbside consultation session, the authorized users, i.e. referring physician and radiologist, collaborate regarding what content (including annotations provided by the annotator tool 539) to append to the signing physician's report, such as among others an official radiology report, with the annotator tool 539. In one aspect, while signing-off on the official report, the signed physician applies personal, professional deference to the proposed appended content before appending the content as an addendum but is not obligated to enter at least part of the proposed content from the physician curbside consultation session as an addendum to the official report. As a further option, the tooling module 530 includes a lock-command feature for deactivating the editor tools. as the reviewing physician (such as among others a radiologist) affixes a signature to the official report (such as among others a radiologists report) to prevent appending further content including annotations to the official report in compliance with government regulations. Optionally, the tooling module 530 includes a lock-command feature for deactivating all operations of the cloud viewing system 510 as the reviewing physician affixes a signature to the official report to prevent appending further content including annotations to the official report in compliance with government regulations.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

I claim:

1. A method of medical consultation comprising the steps of:
verifying user authorizations of a requesting user with respect to a viewing system,
the viewing system includes a cloud viewing network,
the cloud viewing network including a non-diagnostic viewing module; and
receiving, with successful verification from the viewing system, user network status of at least one authorized user of the viewing system.

2. The method of medical consultation according to claim 1 wherein the authorizations are in compliance with government regulations regarding electronic protected health information.

3. The method of medical consultation according to claim 1 further comprising the step of sharing network status in real-time between the requesting user and the at least one authorized user of the viewing system.

4. The method of medical consultation according to claim 1 wherein at least one authorization is based on occupational roles defining each user such that the degree to which the requesting user interfaces with at least one authorized user depends at least in part each occupational role shared between the requesting user and the at least one authorized user.

5. The method of medical consultation according to claim 1 further comprising the step of receiving a consultation session invitation from a first authorized user.

6. The method of medical consultation according to claim 5 further comprising the step of engaging a consultation session timer function sequence on receipt of the consultation session invitation from the first authorized user.

7. The method of medical consultation according to claim 5 further comprising the step of querying the first authorized user, after no reply to the consultation session invitation, whether to either asynchronously consult with the at least one authorized user receiving the consultation session invitation or select another user for subsequently receiving the consultation session invitation from the first authorized user.

8. The method of medical consultation according to claim 5 further comprising the step of accepting the consultation session invitation and establishing a consultation session via the non-diagnostic viewing module.

9. The method of medical consultation according to claim 8 further comprising the step of assigning government regulation compliant metadata with an update function during the consultation session.

10. The method of medical consultation according to claim 8 further comprising the step of appending the consultation session to a physicians' official report.

11. A method of radiological consultation comprising the steps of:
verifying user authorizations of a requesting user with respect to a viewing system,
the viewing system including a diagnostic radiology imaging system and a cloud viewing network,
the diagnostic radiology imaging system including a Picture Archiving and Communication System (PACS),
the cloud viewing network including a non-diagnostic viewing module,
the non-diagnostic viewing module includes a non-diagnostic radiological viewer,
the non-diagnostic radiological viewer communicatively connected to the PACS;
and
sharing user network status between the requesting user and the at least one authorized user of the viewing system.

12. The method of radiological consultation according to claim 11 further comprising step of sending a physician curbside consultation invitation from a referring physician authorized user to at least one radiologist authorized user for receiving the physician curbside consultation invitation to initiate a cloud-based consultation session with the referring physician authorized user via the non-diagnostic viewing module and engaging a consultation session timer function sequence on receipt of the physician curbside consultation invitation.

13. The method of radiological consultation according to claim 12 further comprising step of marking a non-diagnostic PACs image file displayed on the non-diagnostic radiological viewer.

14. The method of radiological consultation according to claim 12 further comprising the step of saving the marked non-diagnostic PACS image file.

15. The method of radiological consultation according to claim 12 further comprising the step of saving the associated digital files from physician curbside consultation session.

16. The method of radiological consultation according to claim 12 further comprising the step of deleting the physician curbside consultation from the cloud viewing network.

17. A viewing system comprising:
an electronic medical records system,
the electronic medical records system including a Picture Archiving and Communication System (PACS),
the PACS including a PACS image file;
a cloud viewing network,
the cloud viewing network including a non-diagnostic viewing module,
the non-diagnostic viewing module including a non-diagnostic radiological viewer and a tooling module,
the non-diagnostic radiological viewer communicatively connected to the PACS; and
at least one dashboard, the at least one dashboard includes at least one graphical user interface for operating the cloud viewing network.

18. The viewing system according to claim 17 wherein the non-diagnostic radiological viewer displays a non-diagnostic PACs image file based on the PACS image file, the non-diagnostic PACS file displayed by the at least one dashboard.

19. The viewing system according to claim 17 wherein at least one dashboard of the cloud viewing network includes a network status social media indicator.

20. The viewing system according to claim 17 wherein at least one dashboard of the cloud viewing network includes a synchronous/asynchronous communications monitor.

21. The viewing system according to claim 17 wherein at least one dashboard of the cloud viewing network includes a consultation session initiator, the consultation session initiator triggers a consultation session, the consultation session facilitated on the at least one dashboard.

22. The viewing system according to claim 17 wherein the tooling module includes an annotator tool for appending the consultation session to a physicians' official report.

23. The viewing system according to claim 17 wherein the tooling module includes an update function, and wherein the editor tool assigns a regulatory-compliant metadata stamp by the update function.

24. The viewing system according to claim 17 wherein non-diagnostic radiological viewer receives a lock-command from the reviewing physician on affixing a signature to the radiologists report to deactivate the editor tool.

25. The viewing system according to claim 17 wherein the tooling module includes a feedback interface.

26. The viewing system according to claim 17 wherein the tooling module includes a favorites interface.

27. The viewing system according to claim 17 wherein the tooling module includes a workflow distribution navigator.

28. A viewing system comprising:
a diagnostic radiology imaging system,
the diagnostic radiology imaging system including a Picture Archiving and Communication System (PACS),
the PACS including a PACS image file;
a cloud viewing network,
the cloud viewing network including a non-diagnostic viewing module,
the non-diagnostic viewing module including a non-diagnostic radiological viewer and a tooling module,
the non-diagnostic radiological viewer communicatively connected to the PACS,
the non-diagnostic radiological viewer includes a non-diagnostic PACs Image file based on the PACS image file; and
a radiology social network referral system,
the radiology social network referral system communicatively connected to the cloud viewing network and the diagnostic radiology imaging system,
the radiology social network referral system includes a health administration server,
the health administration server communicatively connected to the diagnostic viewer,
the health administration server includes a regulation function, the regulation function generates at least one dashboard, each dashboard generated by the radiology social network referral system includes at least one user interface component for operating the secured, cloud viewing network.

29. The viewing system according to claim 28 wherein the non-diagnostic radiological viewer displays a non-diagnostic PACs image file based on the PACS image file, the non-diagnostic PACS file displayed by the at least one dashboard.

30. The viewing system according to claim 28 wherein at least one dashboard of the cloud viewing network includes a consultation session initiator, the consultation session initiator triggers a physician curbside consultation session.
